(19) United States
(12) Patent Application Publication
(10) Pub. No.: US 2026/0029500 A1
(43) Pub. Date: Jan. 29, 2026

(54) METHODS AND APPARATUS FOR POSITIONING OF A MOBILE TERMINAL

(71) Applicant: European Space Agency, Paris (FR)

(72) Inventors: Felix Abel, Noordwijk (NL); Florin-Catalin Grec, Noordwijk (NL); Rigas Themistoklis Ioannidis, Noordwijk (NL)

(21) Appl. No.: 19/099,719

(22) PCT Filed: Aug. 1, 2023
(86) PCT No.: PCT/EP2023/071321

§ 371 Date: Jan. 29, 2025

(30) Foreign Application Priority Data
Aug. 1, 2022 (EP) 22188118.8
Aug. 1, 2022 (EP) 22188121.2
Aug. 1, 2022 (EP) 22188123.8

(51) Int. Cl. G01S 5/00; G01S 5/06

(52) U.S. Cl. CPC G01S 5/0027; G01S 5/06

(57) ABSTRACT

A method of air-based and/or space-based positioning of a mobile terminal for determining or verifying a position of the mobile terminal includes: at an airborne or spaceborne transmitter, transmitting a first radio signal to the mobile terminal prompting the mobile terminal to transmit a second radio signal, wherein the first radio signal corresponds to a first message; at the mobile terminal, in response to receiving the first radio signal, transmitting the second radio signal, wherein the second radio signal corresponds to a second message; receiving the second radio signal at a plurality of airborne or spaceborne receivers; and determining or verifying the position of the mobile terminal based on a time of transmission of the first radio signal at the transmitter and times of reception of the second radio signal at respective ones of the receivers. Further disclosed is a constellation of satellites for space-based positioning of a mobile terminal.

### BACKGROUND

### Technical Field

This application relates to the field of air-based or space-based (e.g., satellite-based) positioning. The application particularly relates to techniques for air-based or space-based positioning of a mobile terminal, and to constellations of satellites implementing such techniques. The application further relates to such techniques that use two-way position validation and determination.

### Description of the Related Art

Current satellite-based positioning methods typically rely on signals broadcast by a Global Navigation Satellite System (GNSS). For uses cases-such as asset tracking, for example—where the position of an agent A (e.g., a mobile terminal) needs to be reported to another agent B, a malevolent agent A could report a falsified GNSS position. This vulnerability of the asset tracking application is a gap in capabilities of state-of-the art GNSS-based positioning techniques. Meanwhile, asset trackers are projected to be the fastest-growing GNSS device type.

Thus, there is a need for improved techniques for positioning of mobile terminals. There is particular need for such techniques that are not affected by errors in, or intentional manipulation of, data provided by the mobile terminals.

### BRIEF SUMMARY AND GENERAL DESCRIPTION

In view of some or all of these needs, the present disclosure proposes a method of air-based and/or space-based (e.g., satellite-based) positioning of a mobile terminal and a constellation of a plurality of satellites for positioning of a mobile terminal, having the features of the respective independent claims.

An aspect of the disclosure relates to a method of air-based and/or space-based (e.g., satellite-based) positioning of a mobile terminal for determining or verifying a position of the mobile terminal. The method may include, at an airborne or spaceborne transmitter, transmitting a first radio signal to the mobile terminal for prompting the mobile terminal to transmit a second radio signal. The first radio signal may correspond to a first message. The first radio signal may be repeatedly or periodically sent by the airborne or spaceborne transmitter. The method may further include, at the mobile terminal, in response to receiving the first radio signal, transmitting the second radio signal. Therein, the second radio signal may correspond to a second message. The method may further include receiving the second radio signal at a plurality of airborne or spaceborne receivers. The method may yet further include determining or verifying the position of the mobile terminal based on a time of transmission of the first radio signal at the airborne or spaceborne transmitter and times of reception of the second radio signal at respective ones of the plurality of airborne or spaceborne receivers. Determining or verifying the position of the mobile terminal may be performed at a processing node. The processing node may be provided at one of the transmitter or the plurality of receivers, or separate therefrom, for example as a central node (e.g., ground station).

Thereby, the mobile terminal can be reliably positioned (i.e., its position can be determined) even when it provides falsified data, or it can alternatively be verified whether the mobile terminal is indeed at a self-reported position. This can be achieved with marginal increase in complexity in the transmitter and receiver payloads.

In some embodiments, the first message may include a first identifier that identifies the airborne or spaceborne transmitter. The first identifier may include a transmitter number or a satellite number, for example.

In some embodiments, the first identifier may include a pseudo-random bit sequence that is repeatedly updated at the airborne or spaceborne transmitter. For example, the random bit sequence may be updated periodically, at predefined time intervals, or at predefined timings. If the first radio signal is periodically transmitted, the pseudo-random bit sequence may be changed from one instance of the first radio signal to the next. In any case, the pseudo-random bit sequence may be updated so that it changes from one instance of the first radio signal to the next.

In some embodiments, the second message may include a second identifier identifying the mobile terminal. This the second identifier may include a portion that is generated, at the mobile terminal, based on the first identifier. By including part of the first identifier into the second identifier, message authenticity can be ensured and leeway for spoofing by the mobile terminal is further reduced.

In some embodiments, the method may further include measuring, at respective ones of the plurality of airborne or spaceborne receivers, frequencies of the second radio signal upon arrival. Then, determining or verifying the position of the mobile terminal may be further based on the frequencies of the second radio signal measured at respective ones of the plurality of airborne or spaceborne receivers.

In some embodiments, the second message may further include an indication of a frequency of transmission (e.g., carrier frequency) of the second radio signal at the mobile terminal. Then, determining or verifying the position of the mobile terminal may be further based on the frequency of transmission of the second radio signal at the mobile terminal. In such cases, the method may further comprise determining a (radial) velocity of the mobile terminal, for example based on a determined Doppler frequency shift. Taking into account frequency measurements (and based thereon, Doppler frequency shifts) in determining or verifying the mobile terminal's position can increase accuracy of determination and/or reduce the number of independent receivers that are required for the determination.

In some embodiments, the second message may include an indication of one or more parameters for assisting determination or verification of the position of the mobile terminal. The one or more parameters for assisting determination or verification of the position of the mobile terminal may include at least one of: a transmission delay between reception of the first radio signal and transmission of the second radio signal at the mobile terminal, and one or more components of a position of the mobile terminal. Then, determining or verifying the position of the mobile terminal may be further based on the one or more parameters for assisting determination or verification of the position of the mobile terminal. The transmission delay may correspond to or include a processing delay at the mobile terminal. The position of the mobile terminal may be a self-reported position, for example.

In some embodiments, determining or verifying the position of the mobile terminal may include determining a cost function based on the time of transmission of the first radio signal at the airborne or spaceborne transmitter and the times of reception of the second radio signal at the respective ones of the plurality of airborne or spaceborne receivers. Determining or verifying the position of the mobile terminal may further include determining or verifying the position of the mobile terminal based on the cost function.

In some embodiments, the cost function may be further based on the frequencies of the second radio signal measured at respective ones of the plurality of airborne or spaceborne receivers. Additionally or alternatively, the cost function may be further based on the frequency of transmission of the second radio signal. Additionally or alternatively, the cost function may be further based on the one or more parameters for assisting determination or verification of the position of the mobile terminal. For example, the cost function may be further based on the transmission delay between reception of the first radio signal and transmission of the second radio signal at the mobile terminal.

In some embodiments, determining the position of the mobile terminal based on the cost function may involve minimizing the cost function to estimate the position of the mobile terminal. The cost function may be minimized using least-squares techniques, for example.

In some embodiments, determining the position of the mobile terminal using the cost function may involve jointly determining a position of the mobile terminal and a transmission delay between reception of the first radio signal and transmission of the second radio signal at the mobile terminal that minimize the cost function.

In some embodiments, the second message may include an indication of a self-reported position of the mobile terminal. Then, the cost function may be further based on the self-reported position. For example, the self-reported position of the mobile terminal may be a Global Navigation Satellite System, GNSS, based position.

In some embodiments, verifying the position of the mobile terminal may involve comparing the cost function to a threshold. The threshold may be a predetermined threshold, for example. The self-reported position of the mobile terminal may be considered verified if the cost function does not exceed the threshold (or is smaller than the threshold).

In some embodiments, the first message may include an indication of a time of transmission of the first radio signal at the airborne or spaceborne transmitter.

In some embodiments, the method may further include, at the airborne or spaceborne transmitter, encrypting information bits representing the first identifier. Additionally of alternatively, the method may further include, at the mobile terminal, encrypting information bits representing the second identifier.

In some embodiments, the cost function may be given by

$${ε}_{T , rms} = \sqrt{\frac{1}{N} {\sum }_{k = 1}^{N} {( {ε}_{T , k} )}^{2}} ,$$

with ε_{T,k}=∥p_{UE}−p_{Sk}∥+∥p_{UE}−p_{S1}∥+c (t_{tx,S1}+Δt_{UE}−t_{rx,Sk,S1}). Here, N may denote the number of airborne or spaceborne receivers, k=1, . . . , N may denote a given one among the plurality of airborne or spaceborne receivers, p_{UE} may denote the position of the mobile terminal, p_{Sk} may denote a position of the k-th airborne or spaceborne receiver, p_{S1} may denote a position of the airborne or spaceborne transmitter, t_{tx,S1} may denote the time of transmission of the first radio signal at the airborne or spaceborne transmitter, t_{rx,Sk,S1} may denote the time of reception of the second radio signal at the k-th airborne or spaceborne receiver, Δt_{UE} may denote the transmission delay between reception of the first radio signal and transmission of the second radio signal at the mobile terminal, and c may denote the speed of light.

In some embodiments, the cost function may be given by

$${ε}_{TF , rms} = \sqrt{\frac{1}{2 N} {\sum }_{k = 1}^{N} {( {ε}_{T , k} )}^{2} + {( {ε}_{F , k} )}^{2}} ,$$

$$with {ε}_{T , k} = ‖ {p}_{UE} - {p}_{Sk} ‖ + ‖ {p}_{UE} - {p}_{S 1} ‖ + c ( {t}_{tx , S 1} + Δ {t}_{UE} - {t}_{rx , Sk , S 1} ) and$$

$${ε}_{F , k} = w ( {v}_{Sk}^{T} \frac{{p}_{UE} - {p}_{Sk}}{‖ {p}_{UE} - {p}_{Sk} ‖} - c \frac{{f}_{rx , Sk , S 1} - {f}_{tx , U E}}{{f}_{tx , U E}} ) .$$

Here, N may denote the number of airborne or spaceborne receivers, k=1, . . . , N may denote a given one among the plurality of airborne or spaceborne receivers, p_{UE} may denote the position of the mobile terminal, p_{Sk} may denote a position of the k-th airborne or spaceborne receiver, p_{S1} may denote a position of the airborne or spaceborne transmitter, t_{tx,S1} may denote the time of transmission of the first radio signal at the airborne or spaceborne transmitter, t_{rx,Sk,S1} may denote the time of reception of the second radio signal at the k-th airborne or spaceborne receiver, Δt_{UE} may denote the transmission delay between reception of the first radio signal and transmission of the second radio signal at the mobile terminal, w may denote a weighting factor of unit [seconds], v_{Sk} may denote a velocity of the k-th airborne or spaceborne receiver, f_{tx,UE} may denote the frequency of transmission of the second radio signal at the mobile terminal, f_{rx,Sk,S1} may denote the frequency of the second radio signal measured at the k-th airborne or spaceborne receiver, and c may denote the speed of light.

In some embodiments, the weighting factor w may be given by w=c⁻¹∥p_{UE}−p_{Sk}∥.

In some embodiments, the method may further include collecting, at a processing node, the time of transmission of the first radio signal at the airborne or spaceborne transmitter and the times of reception of the second radio signal at respective ones of the plurality of airborne or spaceborne receivers. Then, the method may further include determining the position of the mobile terminal at the processing node.

In some embodiments, the processing node may be implemented by one or more of: a user terminal, the airborne or spaceborne transmitter, one or more of the airborne or spaceborne receivers, and a ground station.

In some embodiments, the method may further include collecting, at the processing node, the frequency of transmission of the second radio signal at the mobile terminal and/or the frequencies of the second radio signal measured at the respective ones of the plurality of airborne or spaceborne receivers.

In some embodiments, the airborne or spaceborne transmitter and the plurality of airborne or spaceborne receivers may be implemented by a plurality of satellite-based transceivers. The satellites holding the transceivers may be LEO satellites, for example.

Another aspect of the disclosure relates to a constellation of a plurality of satellites for positioning of a mobile terminal. The plurality of satellites (i.e., constellation) may include a first satellite comprising a transmitter for transmitting a first radio signal to the mobile terminal for prompting the mobile terminal to transmit a second radio signal. The first radio signal may correspond to a first message. The second radio signal may correspond to a second message. The plurality of satellites (i.e., constellation) may further include a plurality of second satellites, each comprising a receiver for receiving the second radio signal. The first satellite may be adapted to transmit an indication of a time of transmission of the first radio signal at the airborne or spaceborne transmitter to the mobile terminal (e.g., as part of the first message) or to a processing node. Each of the second satellites may be adapted to transmit an indication of a time of reception of the second radio signal at the respective second satellite to the processing node.

In some embodiments, the processing node may be implemented by one or more of a user terminal, the first satellite, one or more of the second satellites, and/or a ground station.

In some embodiments, the second message may include an indication of a frequency of transmission of the second radio signal at the mobile terminal. Each of the second satellites may be further adapted to transmit the indication of the frequency of transmission of the second radio signal at the mobile terminal and/or an indication of a frequency of the second radio signal measured at the respective second satellite to the processing node.

In some embodiments, the second message may include an indication of one or more parameters for assisting determination or verification of the position of the mobile terminal. The one or more parameters for assisting determination or verification of the position of the mobile terminal may include at least one of: a transmission delay between reception of the first radio signal and transmission of the second radio signal at the mobile terminal and one or more components of a position of the mobile terminal. Then, each of the second satellites may be further adapted to transmit the indication of the one or more parameters for assisting determination or verification of the position of the mobile terminal to the processing node.

In some embodiments, the first message may include a first identifier that identifies the first satellite. Then, the first satellite may be further adapted to transmit the first identifier to the processing node. Additionally or alternatively, the second message may include a second identifier that identifies the mobile terminal. Then, each of the second satellites may be further adapted to transmit the second identifier to the processing node.

It will be appreciated that apparatus features and method steps may be interchanged in many ways. In particular, the details of the disclosed apparatus or system (e.g., satellite or constellation of satellites) can be realized by the corresponding method of operating the apparatus/system or parts thereof, and vice versa, as the skilled person will appreciate. Moreover, any of the above statements made with respect to the apparatus/system are understood to likewise apply to the corresponding method, and vice versa.

### BRIEF DESCRIPTION OF THE SEVERAL VIEWS OF THE DRAWINGS

Example embodiments of the present disclosure are explained below with reference to the accompanying drawings, wherein:

FIG. 1 schematically illustrates an example of an overall framework for employing methods according to embodiments of the disclosure,

FIG. 2 is a flowchart illustrating an example of a method according to embodiments of the disclosure,

FIG. 3 schematically illustrates an example of a message exchange scheme for methods according to embodiments of the disclosure,

FIG. 4 schematically illustrates an example of message content of a downlink message (first message) in methods according to embodiments of the disclosure,

FIG. 5 schematically illustrates an example of message content of an uplink message (second message) in methods according to embodiments of the disclosure,

FIG. 6 includes diagrams showing examples of mean RMS distance error as function of orbit height and user masking angle, respectively, for methods according to embodiments of the disclosure,

FIG. 7 includes diagrams showing examples of mean RMS distance error as function of error standard deviation for honest users and fraudulent users, respectively, for methods according to embodiments of the disclosure,

FIG. 8 includes diagrams showing further examples of mean RMS distance error as function of orbit height and user masking angle, respectively, for methods according to embodiments of the disclosure,

FIG. 9 is a diagram showing another example of mean RMS distance error as function of error standard deviation for honest users and fraudulent users, for methods according to embodiments of the disclosure,

FIG. 10 includes diagrams showing examples of probability distributions of mean RMS distance error for varying orbit height and varying user masking angle, respectively, for methods according to embodiments of the disclosure, and

FIG. 11 is a diagram showing an example of a probability distributions of mean RMS distance error for varying error standard deviation, for methods according to embodiments of the disclosure.

### DETAILED DESCRIPTION

### Introduction

One feasible approach to mitigate the abovementioned issue of vulnerability to accidentally or intentionally false position reports may be to use uplink time difference of arrival (TDOA) positioning. Uplink TDOA positioning methods, as described for example in References [2], [3] (indicated below), use at least four synchronized receivers to timestamp an uplink message from the user, further combining these measurements into three independent TDOA equations allowing to position the user in three dimensions (3D). Current TDOA approaches rely only on the uplink message. Other existing methods employing two-way round-trip time (RTT) measurements are dependent on the user to report correct timestamping.

Further, satellite-based geolocation services can be used to locate an emitter/user. Here one can distinguish between different classes of users based on their level of cooperation. In case of search and rescue (SAR) applications, users are fully cooperative. Examples exist for operational systems like Galileo MEOSAR (Reference [4]) and other projected systems (Reference [5]). The aforementioned methods rely either on uplink TDOA or on the user obtaining its own position via GNSS and supplying it through the uplink message. Access policing for satellite services (Reference [6]) and AIS-based ship tracking (Reference [7]) are examples for the case of partly cooperative or non-trusted users. Again, the positioning for non-trusted users is only based on uplink signals.

In the context of the present disclosure, the terms “partly cooperative user” and “non-trusted user” may be used interchangeably for a user for which it can be assumed that it will transmit uplink signals, either for an intrinsic incentive (e.g., being allowed to use a service) or to avoid regulatory/legal repercussions (e.g., in the case of AIS). It is further assumed that the user might have an incentive to tamper with its uplink signals and the information therein for their own benefit (e.g., self-spoof to cover up illegal fishing activities).

Non-cooperative users by contrast might not have any incentive to conform to a certain pattern or message format for uplink signals. The geolocation of such non-cooperative users may have its main application in a military and law enforcement context, but may also relate to tailoring communication services to a user's location, for example. Operational services are offered for example by Atos (Reference [8]) and Spire (Reference [9]), where the latter can be employed for GNSS interference monitoring. Working with non-cooperative users, these methods rely by definition on one-way uplink signals. Among the different user groups, partly cooperative or non-trusted users are the main targeted group for techniques according to the present disclosure.

For the use case of asset tracking, current solutions exist in various grades for consumer, commercial, and governmental applications, including applications like fleet management (Reference [10]), industrial and livestock tracking (Reference [11]), personal tracking (Reference [12]), or offender tracking (Reference [13]). These techniques rely on a combination of GNSS, terrestrial networks (e.g., WIFI and cellular) and inertial sensors (References [10], [14], [12]). However, barring a special case where multiple WIFI or cellular access points can be used in conjunction, position verification is not possible with current techniques for asset tracking. While measures like hindering physical access to the tracked device and the use of multiple sensors are designed to hamper opportunities for the user to self-spoof or tamper with its device, current access tracking products and services do not offer inherently secure positioning. Furthermore, the dissemination of position information to the asset owner commonly relies on terrestrial infrastructure, typically cellular. This is subject to security and availability problems.

### Detailed Description of Example Embodiments

The present disclosure relates to methods for two-way position validation or position determination of user elements (mobile terminals) by way of a set of airborne or spaceborne nodes (e.g., satellites in low Earth orbit (LEO), other spacecraft, high-altitude platforms, airplanes, balloons, etc.) that can determine the position of a non-trusted user.

While reference throughout the disclosure is frequently made to satellites (in particular, LEO satellites) as transmitters and/or receivers (e.g., transceivers) of radio signals, it is understood that the present disclosure is not so limited and likewise applies to other airborne or spaceborne transceivers (transceiver platforms), such as high-altitude platforms. The present disclosure further relates to techniques employing combinations of different receivers (receiver platforms), including systems comprising satellites and high-altitude platforms. Unless indicated otherwise, it is understood that statements made with regard to satellites likewise apply to other receiver platforms, such as high-altitude platforms.

According to the proposed methods, a downlink signal (first radio signal) is sent from one LEO satellite at time t_{tx,S1} (time of transmission) to the mobile terminal (user element (UE)). The transmitting LEO satellite is a non-limiting example of an airborne or spaceborne transmitter. The mobile terminal then uplinks a signal (second radio signal) that is received by multiple LEO satellites at times t_{rx,Sk,S1} (times of reception). The multiple LEO satellites are non-limiting examples of airborne or spaceborne receivers. Based on the recorded time of transmission at the one LEO satellite and reception by the multiple (e.g., at least four) LEO satellites, the delay between reception and transmission, Δt_{UE} and the three coordinates of the user position p_{UE} can be computed independently of position and timing and information by the UE, for example as described in Eq. (1)-Eq. (4) given below. Notably, in some implementations, the transmitting LEO satellite may be among the multiple receiving LEO satellites.

Detail of geometric and/or temporal aspects of these methods, optional features, message composition, and details of the position computation procedure will be described below.

### Message Exchange Procedure

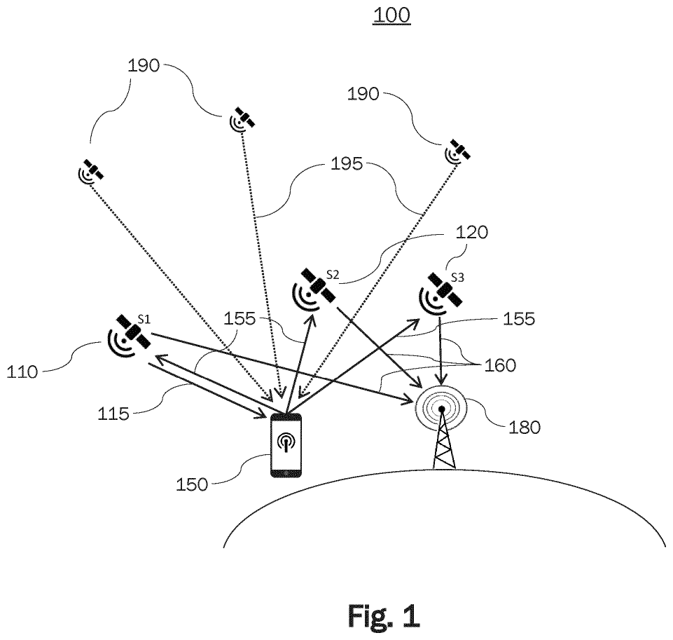

FIG. 1 schematically illustrates an example of a framework (or geometry) 100 for employing techniques according to the present disclosure.

The framework comprises an optional set of GNSS satellites 190, for example in medium Earth orbit (MEO), a mobile terminal (user element) 150 for example located on earth surface or in earth atmosphere, a set (e.g., constellation, or part thereof) of satellites (S1, S2, S3, . . . ) 110, 120, for example in low Earth orbit (LEO), and optionally, a ground station (GS) 180.

FIG. 1 further schematically shows the different stages or steps of methods according to embodiments of the disclosure.
1) At a first stage, which is optional, GNSS satellites 190 transmit navigation signals (GNSS signals) 195 that are received by the mobile terminal 150, which in turn subsequently computes its position based on the GNSS signals 195.
2) At a second stage, one LEO satellite 110 among the LEO satellites transmits a signal (downlink signal, first radio signal) 115 to the mobile terminal 150. This signal 115 includes a unique identifier (first identifier) of the LEO satellite 110 and the time of transmission of the signal at the LEO satellite 110, t_{tx,S1}.
3) At a third stage, the mobile terminal 150 transmits an uplink signal (second radio signal) 155. The uplink signal 155 includes a unique identifier (second identifier) of the mobile terminal 150. As will be described in more detail below, the uplink signal may optionally further include the carrier frequency of the uplink signal, f_{tx,UE}. Alternatively or additionally, the uplink signal may optionally further include the time elapsed between receiving the signaling from the LEO satellite 110 and transmitting the uplink signal 155, Δt_{UE} and/or the reported position of the mobile terminal 150 determined by way of the GNSS, p_{UE}. The uplink signal 155 from the mobile terminal 150 is received at LEO satellites 120 among the LEO satellites. The receiving LEO satellites 120 may or may not include the transmitting LEO satellite 110. The receiving LEO satellites 120 measure (or record) respective times of arrival t_{rx,Sk,S1} of the uplink signal 155. Further, optionally, also frequencies of arrival f_{rx,Sk,S1} of the uplink signal 155 are measured by respective LEO satellites 120.
4) At a fourth stage, all measurements are downlinked to the ground station 180 (alternatively, to one of the LEO satellites, a separate user terminal, or even the mobile terminal 150, depending on the implementation). In any case, the measurements are transmitted to a processing node (i.e., a node having processing capability). The ground station 180 (or processing node in general) then determines or validates the position of the mobile terminal 150 based on the collected data.

It is understood that the position of the transmitter (e.g., satellite) and each receiver (e.g., satellite) at the relevant times are assumed to be known, for example through orbit determination techniques, orbit propagation, ground-based ranging, or other solutions.

Notably, in the framework 100 of FIG. 1, only the mobile terminal 150 and the LEO satellites 110, 120 are strictly required. The set of GNSS satellites 190 in MEO is only required if the UE should determine its position a priori and transmit its position (and possibly retransmission delay Δt_{UE}) to the LEO satellites 110, 120 via the uplink message 155. This provision permits the LEO satellites 110, 120 to confirm or reject the mobile terminal's 150 reported position, for example based on the RMSE using Eq. (2) and Eq. (6) given below, rather than computing it ab initio, for example using Eq. (4) and Eq. (8) given below, thereby saving computational resources. The ground station 180 is only required if the processing is to be performed on ground. The proposed method, however, only requires the measurements/recordings by the transmitting satellite and all receiving satellites to be collected (e.g., fused) in an arbitrary place or at an arbitrary processing node to perform the computation. This processing node could be one of the satellites, or other spaceborne, airborne, or ground-based elements, depending on use cases and implementations.

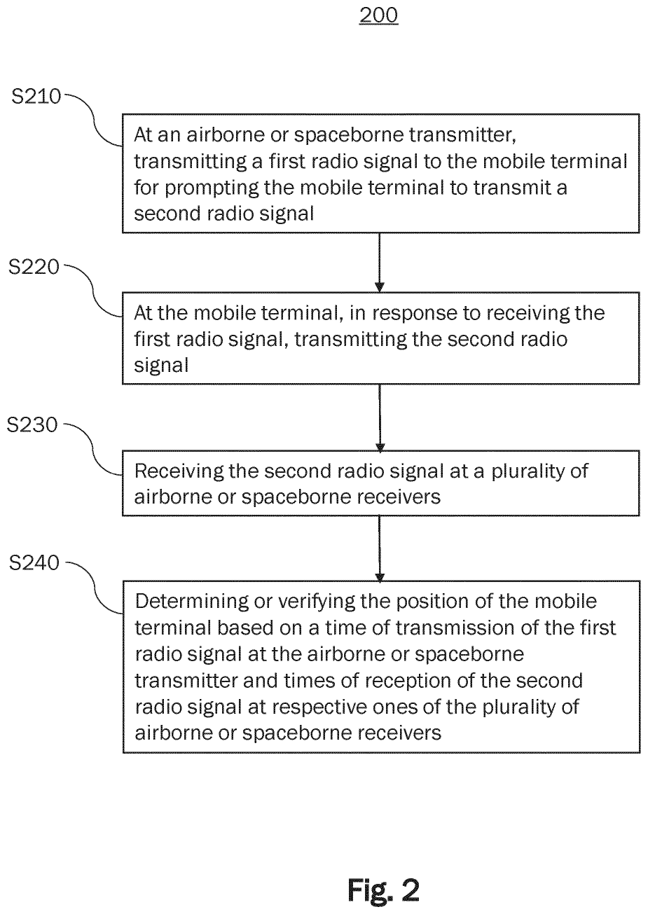

FIG. 2 is a flowchart illustrating an example of a method 200 of air-based and/or space-based positioning of a mobile terminal for determining or verifying a position of the mobile terminal according to embodiments of the disclosure. This method may proceed, for example, in the framework 100 described above.

At step S210, a first radio signal is transmitted, at an airborne or spaceborne transmitter (e.g., the LEO satellite 110 in the example of FIG. 1), to the mobile terminal (e.g., the mobile terminal 150 in the example of FIG. 1). This is done for prompting the mobile terminal to in turn transmit a second radio signal. The first radio signal is understood to correspond to (e.g., comprise, implement) a first message. Further, the first radio signal may be repeatedly or periodically sent by the airborne or spaceborne transmitter.

As noted above, the first message includes a first identifier (unique downlink identifier) that identifies the airborne or spaceborne transmitter. For example, the first identifier may include a (unique) transmitter number or a satellite number, for example. In some embodiments, the unique downlink identifier may fulfill requirements concerning expiration time, non-predictability and/or encryption/privacy.

At step S220, in response to receiving the first radio signal, the second radio signal is transmitted at the mobile terminal. It is understood that the second radio signal corresponds to (e.g., comprises, implements) a second message.

As noted above, the second message includes a second identifier (unique uplink identifier) identifying the mobile terminal. Therein, the second identifier includes at least a portion that is generated, at the mobile terminal, based on the first identifier. This may be done by simply copying the first identifier, or by hashing the first identifier, for example. In some embodiments, the unique uplink identifier may fulfill requirements concerning unique identifiability of the mobile terminal, unique identifiability of the downlink satellite and message, and/or encryption/privacy.

At step S230, the second radio signal is received at a plurality of (e.g., N) airborne or spaceborne receivers (e.g., the LEO satellites 120 in the example of FIG. 1). Each of the receivers' measures/records the time of arrival (time of reception) of the second radio signal at the respective receiver.

At step S240, the position of the mobile terminal is determined or verified based on a time of transmission of the first radio signal at the airborne or spaceborne transmitter and times of reception of the second radio signal at respective ones of the plurality of airborne or spaceborne receivers.

Determining or verifying the position of the mobile terminal at this step may be performed at a processing node. This processing node may be provided at one of the transmitter or the plurality of receivers, or separate therefrom, for example as a central node (e.g., ground station). In general, the processing node may be implemented by one or more of: a user terminal, the airborne or spaceborne transmitter, one or more of the airborne or spaceborne receivers, and a ground station.

Thus, method 200 may further comprise a step (not shown in FIG. 2) before step S240 of collecting (or aggregating), at the processing node, the time of transmission of the first radio signal at the airborne or spaceborne transmitter and the times of reception of the second radio signal at respective ones of the plurality of airborne or spaceborne receivers. It is understood that further information as needed at step S240 (e.g., information as described below) may be collected as well at the processing node.

Method 200 may further comprise an optional step (not shown in FIG. 2) of determining whether the mobile terminal is at an allowed position, based on the position determined or verified at step S240. If so, the user of the mobile terminal may be regarded as a legitimate user, otherwise, as a malicious or non-legitimate user. Limits of what is considered an allowable position may be determined by a service agreement between the user of the mobile terminal and a service provider, for example.

As noted earlier, it is understood that the airborne or spaceborne transmitter and the plurality of airborne or spaceborne receivers may be implemented, without intended limitation, by a plurality of satellite-based transceivers, for example. The satellites holding the transceivers may be LEO satellites (e.g., LEO-PNT satellites), for example.

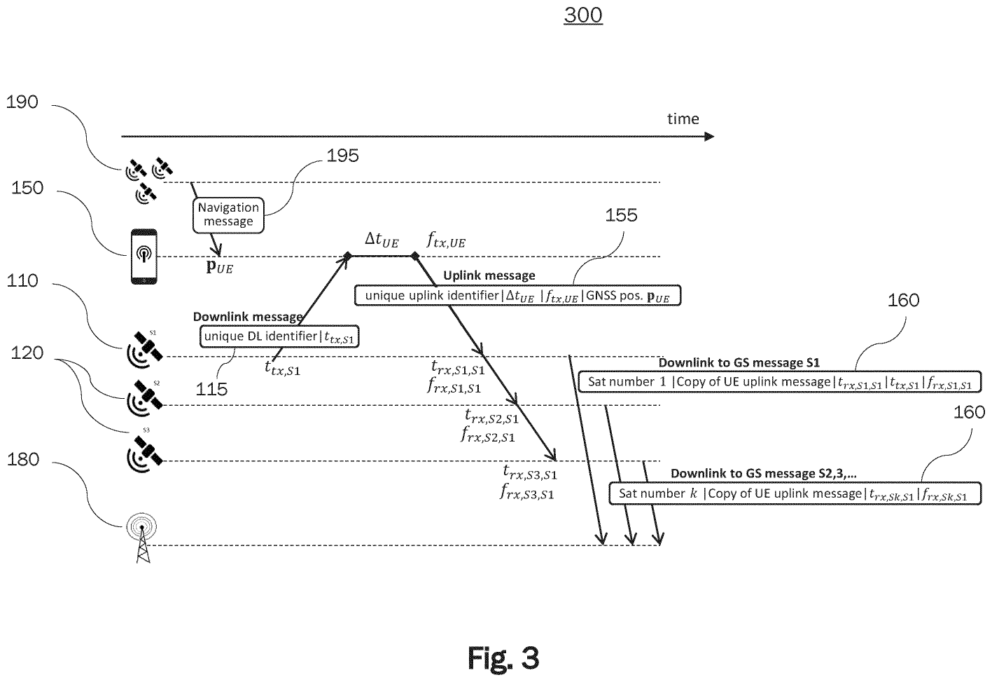

FIG. 3 schematically illustrates an example 300 of message composition and temporal sequence of message transmission for methods according to embodiments of the disclosure.

Time is shown on the horizontal axis. The vertical axis shows the different transmitting or receiving entities as defined above. Importantly, as noted above, at least some elements of message content and at least some interactions are optional in the sense that they are only required for certain optional features of the proposed methods. Further, boxes denote messages and arrows denote their transmission.

Optionally, the mobile terminal 150 may determine its position p_{UE} based on one or more GNSS messages 195 transmitted by the GNSS satellites.

At a time t_{tx,S1}, the airborne or spaceborne transmitter (or transmitter for short) transmits the first radio signal 115, corresponding to the first message (downlink message) to the mobile terminal 150. The first message includes the first identifier (unique downlink identifier) and can optionally further include the time of transmission t_{tx,S1}.

Prompted by the first radio signal, a time interval Δt_{UE} after reception of the first message, the mobile terminal 150 transmits the second radio signal 155, corresponding to the second message (uplink message), which is then received by the multiple airborne or spaceborne receivers 120 (or receivers for short) at respective times t_{rx,Sk,S1}, with index k indicating the respective receiver. The second message includes the second identifier (unique uplink identifier). Optionally, the second message can further include any, some, or all of an indication of the time interval Δt_{UE}, an indication of a carrier frequency f_{tx,UE} of the second radio signal 155, and the self-reported position of the mobile terminal 150 p_{UE}, for example determined based on the one or more GNSS messages 195.

The receivers 120 then each send a downlink to ground station message 160 (or in general, downlink to processing node message) to the ground station 180 (or in general, to the processing node). The downlink to ground station message 160 includes an identification of the respective receiver, a copy or digest (e.g., hash) of the uplink message, the time of transmission t_{tx,S1} of the first radio signal 115 at the transmitter (unless this information is provided to the ground station 180 via alternative channels, for example directly by the transmitter 110), the time of reception t_{rx,Sk,S1} at the respective receiver 120, and optionally the frequency of the second radio signal f_{rx,Sk,S1} measured at the respective receiver 120.

In the above, the optional frequency measurements and message content of the second messages relating to the carrier frequency of the second radio signal may be used for joint time-frequency domain positioning.

In such an implementation, step S230 of method 200 may comprise measuring, at respective ones of the plurality of airborne or spaceborne receivers, frequencies f_{rx,Sk,S1} of the second radio signal upon arrival. Accordingly, determining or verifying the position of the mobile terminal at step S240 may then further be based on the frequencies f_{rx,Sk,S1} of the second radio signal measured at respective ones of the plurality of airborne or spaceborne receivers 120. Additionally or alternatively, the second message transmitted at step S220 may include an indication of a frequency f_{tx,US} of transmission (e.g., carrier frequency) of the second radio signal at the mobile terminal. Accordingly, determining or verifying the position of the mobile terminal at step S240 may be further based on the frequency of transmission f_{tx,UE} of the second radio signal at the mobile terminal.

Details of determining or verifying the position of the mobile terminal using the frequency information will be described below. In any case, if any item of the optional information relating to the frequency of the second radio signal is not available at the processing node, time-domain only positioning can be employed. This may require data from more receivers 120 (e.g., require more satellites). On the other hand, if the information is available, it may be further used for determining a (radial) velocity of the mobile terminal, for example based on a determined Doppler frequency shift.

Further, elements and message content for self-reported (e.g., GNSS-based) position can be used for position validation.

In such an implementation (which can be combined with the above implementation using frequency information), the second message transmitted at step S220 of method 200 may include an indication of one or more components of the (self-reported) position of the mobile terminal. Accordingly, determining or verifying the position of the mobile terminal at step S240 may be further based on the one or more components of the position p_{UE} of the mobile terminal.

Details of verifying the self-reported position of the mobile terminal will be described below. If the self-reported position is not available, the position of the mobile terminal may be determined ab initio (i.e., from scratch), which may be computationally more expensive.

Finally, in a further implementation (which can be combined with either one or both of the above implementations) the second message transmitted at step S220 of method 200 may include an indication of the transmission delay (retransmission delay) Δt_{UE} between reception of the first radio signal and transmission of the second radio signal at the mobile terminal. Accordingly, determining or verifying the position of the mobile terminal at step S240 may be further based on the transmission delay. This transmission delay Δt_{UE} may correspond to or include a processing delay at the mobile terminal.

In general, the second message transmitted at step S220 of method 200 may include one or more parameters for assisting determination or verification of the position of the mobile terminal. These parameters may be said to include the aforementioned one or more components of the position p_{UE} of the mobile terminal and/or the transmission delay Δt_{UE}, but may also include additional information.

### Position Computation

Next, details on techniques and equations for the two-way positioning computation (e.g., at step S240 of method 200) will be described.

In general, determining or verifying the position of the mobile terminal (e.g., at step S240) may be based on a cost function. To this end, methods according to embodiments of the disclosure may further foresee determining such cost function. In a minimal case, the cost function may be for example based on the time of transmission t_{tx,S1} of the first radio signal at the airborne or spaceborne transmitter and the times of reception t_{rx,Sk,S1} of the second radio signal at the respective ones of the plurality of airborne or spaceborne receivers.

The cost function may be further based on one or more parameters for assisting determination or verification of the position of the mobile terminal. These may include, as described above, at least one of the transmission delay Δt_{UE} between reception of the first radio signal and transmission of the second radio signal at the mobile terminal, and one or more (e.g., all) components of the position p_{UE} of the mobile terminal. That is, the cost function may be based on, in addition to the time of transmission t_{tx,S1} of the first radio signal at the airborne or spaceborne transmitter and the times of reception t_{rx,Sk,S1} of the second radio signal at the respective ones of the plurality of airborne or spaceborne receivers, the transmission delay Δt_{UE} at the mobile terminal and/or the self-reported position p_{UE} of the mobile terminal. As noted above, the self-reported position may be GNSS-based, for example.

Based on the aggregated time measurements at the N satellites (or in general, the airborne or spaceborne receivers) 120, the distance based on the satellite and user positions can be compared to the measured two-way propagation time of the signal. This may be done using a cost function, as noted above. For example, the cost function in meters for each receiving satellite k may be given by

$${ε}_{T , k} = ‖ {p}_{UE} - {P}_{Sk} ‖ + ‖ {p}_{UE} - {p}_{S 1} ‖ + c ( {t}_{tx , S 1} + Δ {t}_{UE} - {t}_{rx , Sk , S 1} ) , \qquad ( 1 )$$

where N denotes the number of airborne or spaceborne receivers, k=1, . . . , N denotes a given one among the plurality of airborne or spaceborne receivers, p_{UE} denotes the position of the mobile terminal, p_{Sk} denotes the position of the k-th receiver (e.g., LEO satellite), p_{S1} denotes a position of the airborne or spaceborne transmitter, t_{tx,S1} denotes the transmission time at the transmitter (e.g., the one transmitting LEO satellite), t_{rx,Sk,S1} denotes the reception time at the k-th receiver, and c is the speed of light.

The quantities p_{UE} and Δt_{UE} represent the position of the user element and the time delay (retransmission delay) at the user element, respectively, and are to be validated if available (and otherwise, are to be determined, as described below). For example, if the mobile terminal (user element) provides its position p_{UE} and delay Δt_{UE}, the root mean square (RMS) error using measurements from all N satellites can be computed as

$${ε}_{T , rms} = \sqrt{\frac{1}{N} {\sum }_{k = 1}^{N} {ε}_{T , k}^{2}} . \qquad ( 2 )$$

The results for the RMS error can then be compared against a threshold,

$${ε}_{T , rms} \leq {ε}_{threshold} . \qquad ( 3 )$$

If the condition holds (i.e., if the cost function does not exceed the threshold (or alternatively, is smaller than the threshold)), the user's reported position can be judged as validated, otherwise it is judged to be false. The acceptable threshold may depend on application needs and/or user element and satellites capabilities. For example, the threshold may be a predetermined threshold.

Thus, verifying the position of the mobile terminal at step S240 of method 200 may involve comparing the cost function to a threshold.

In case the mobile terminal (e.g., user element) does not provide its position and/or transmission delay, the unknowns can be estimated by minimizing RMSE as

$${[ \begin{matrix}{\hat{p}}_{UE} & {UE}_{}\end{matrix} ]}^{T} = arg {min}_{{[ \begin{matrix}{\hat{p}}_{UE} & {UE}_{}\end{matrix} ]}^{T}} ( {ε}_{T , rms} ) . \qquad ( 4 )$$

Accordingly, determining the position of the mobile terminal based on the cost function at step S240 of method 200 may involve minimizing the cost function to estimate the position of the mobile terminal. This may be done using least-squares techniques, for example. Further, determining the position of the mobile terminal using the cost function at step S240 may involve jointly determining a position of the mobile terminal and a transmission delay between reception of the first radio signal and transmission of the second radio signal at the mobile terminal that minimize the cost function.

To validate or determine the user's three-dimensional (3D) position, thus in total four unknown parameters, at least N=4 receivers (e.g., satellites) are required. More generally, N≥N_{D}+1, where N_{D} is the dimension of the space.

In general, any information entering the cost functions defined throughout the present disclosure may be (jointly) determined by minimizing the error function, for example using least squares techniques. It is understood that the number N of independent receivers required for the task may then depend on the number of parameters that are to be jointly determined.

In addition to the above parameters and quantities entering the cost function, the cost function may be further based on the frequencies of the second radio signal measured at respective ones of the plurality of airborne or spaceborne receivers and/or the frequency of transmission of the second radio signal.

Then, in case the frequency measurements are to be used in addition to time measurements, an additional contribution to the cost function in frequency domain may be defined that compares the Doppler frequency to the expected Doppler frequency based on the positions of satellites k and the mobile terminal (user element), and the (known) velocity v_{Sk} of the satellite k,

$${ε}_{F , k} = w ( {v}_{Sk}^{T} \frac{{p}_{UE} - {p}_{Sk}}{‖ {p}_{UE} - {p}_{Sk} ‖} - c \frac{{f}_{rx , Sk , S 1} - {f}_{tx , UE}}{{f}_{tx , UE}} ) , \qquad ( 5 )$$

with weighting factor w. The weighting factor w (of unit [seconds]) is necessary for achieving the same units for contributions ε_{T,k} and ε_{F,k} to the cost function, and/or for adjusting the relative importance of each contribution in the overall cost function, depending on expected accuracies of (or confidence in) measurements entering the contributions, for example. Without intended limitation, the weighting factor w may be given for example by

$$w = {c}^{- 1} ‖ {p}_{UE} - {P}_{Sk} ‖ , \qquad ( 5 a )$$

to ensure that ε_{F,k} has the unit [meters]. This particular example of the weighting factor w may be said to scale the velocity error by the uplink signal propagation time.

The joint time frequency cost function may then be given by, for example

$${ε}_{TF , rms} = \sqrt{\frac{1}{2 N} {\sum }_{k = 1}^{N} {( {ε}_{T , k} )}^{2} + {( {ε}_{F , k} )}^{2}} . \qquad ( 6 )$$

and the RMSE may be computed as a joint time-frequency error.

In Eqs. (5), (5a), and (6), N denotes the number of airborne or spaceborne receivers, k=1, . . . , N denotes a given one among the plurality of airborne or spaceborne receivers, p_{UE} denotes the position of the mobile terminal, p_{Sk} denotes a position of the k-th airborne or spaceborne receiver, p_{S1} denotes a position of the airborne or spaceborne transmitter, t_{tx,S1} denotes the time of transmission of the first radio signal at the airborne or spaceborne transmitter, t_{rx,Sk,S1} denotes the time of reception of the second radio signal at the k-th airborne or spaceborne receiver, Δt_{UE} denotes the transmission delay between reception of the first radio signal and transmission of the second radio signal at the mobile terminal, v_{Sk} denotes a velocity of the k-th airborne or spaceborne receiver, f_{tx,UE} denotes the frequency of transmission of the second radio signal at the mobile terminal, and f_{rx,Sk,S1} denotes the frequency of the second radio signal measured at the k-th airborne or spaceborne receiver.

If the frequency information is available, it is understood that it may be collected at the processing node along with the time information for determining or verifying the position of the mobile terminal.

By the above, two independent equations-one in time and one in frequency domain—can be used per satellite, reducing the number of satellites required to at least N=3 for 3D positioning, or more generally to

$$N \geq ⌈ \frac{{N}_{D} + 2}{2} ⌉ .$$

The position validation or computation equations can be obtained by extending Eq. (3), (4) to the frequency domain as

$${ε}_{TF , rms} \leq {ε}_{threshold} , \qquad ( 7 )$$

$${[ \begin{matrix}{\hat{p}}_{UE} & {UE}_{} & {\hat{f}}_{tx , UE}\end{matrix} ]}^{T} = arg {min}_{{[ \begin{matrix}{\hat{p}}_{UE} & {UE}_{} & {\hat{f}}_{tx , UE}\end{matrix} ]}^{T}} ( {ε}_{TF , rms} ) . \qquad ( 8 )$$

An example of a derivation for Eq. (1) and Eq. (5) is given in Appendix A.

### Message Composition

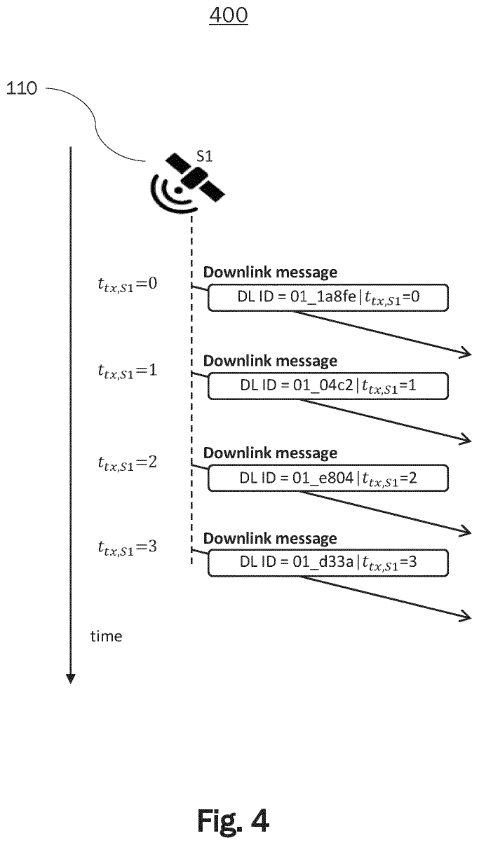

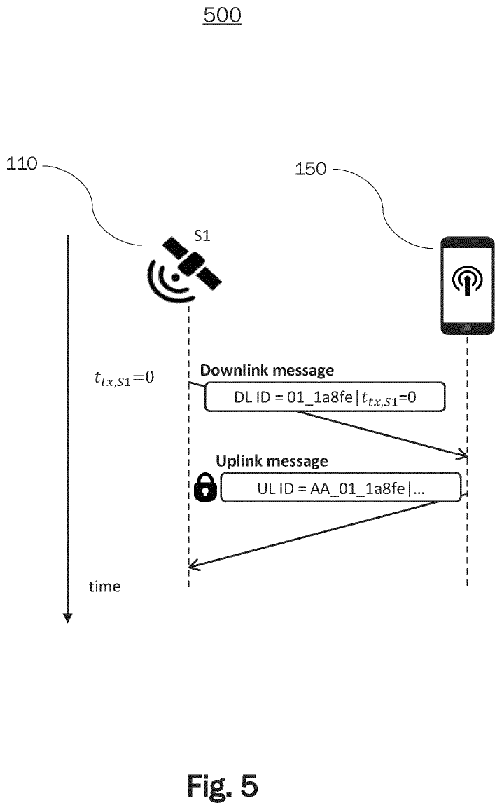

Next, an example of a content (e.g., minimal content) of downlink and uplink messages will be described. FIG. 4 schematically illustrates an example of the structure of a downlink message (first message) and FIG. 5 schematically illustrates an example of the structure of an uplink message (second message.)

In the present example, the downlink message (first message) transmits as core part a downlink identifier (DL ID; first identifier), together with the time of transmission t_{tx,S1} of the downlink message at the transmitter. As shown in FIG. 4, the downlink identifier may include a satellite number (e.g., “01”). It may further include a (pseudo-)random, non-predictable bit sequence (e.g., “1a8fe”, “04c2”, “e804”, “d33a”) that is repeatedly updated at the transmitter. For example, the random bit sequence may be renewed after an expiration time tₑₓₚ. That is, the random bit sequence may be updated periodically, at predefined time intervals, or at predefined timings. If the first radio signal is periodically transmitted, the (pseudo-)random bit sequence may be changed from one instance of the first radio signal to the next. In any case, the pseudo-random bit sequence may be updated such that it changes from one instance of the first radio signal to the next, to increase robustness of the system against spoofing.

In an operational system, multiple satellites would downlink simultaneously. As further shown in the example of FIG. 4, the messages would be sent repeatedly either in a continuous or periodical mode, hence the random bit sequence to distinguish individual messages by the same satellites. The non-predictability requirement serves the purpose of preventing delay attacks and other sophisticated spoofing attacks creating artificial messages.

Optionally, the downlink message could be encrypted, such that only selected, privileged users can decode the downlink. Such a provision would allow further attack protection, preventing malicious users from understanding the message structure. Thus, method 200 described above may further comprise an optional step of, at the airborne or spaceborne transmitter, encrypting information bits representing the first identifier (downlink identifier).

Besides, the downlink message could contain additional information on flow control, uplink access, cryptography and/or other contents typical for a navigation message.

Referring now to the example of FIG. 5, the uplink message (second message) contains as core element an uplink identifier (second identifier). The uplink identifier may comprise a user number (e.g., “AA”), a copy of the downlink identifier (e.g., “2a8fe”), or any combination or hash thereof. The purpose of the uplink message is the identification of the mobile terminal (e.g., user element) to the receiving satellites, the identification of the downlink satellite, and random sequence received by the UE.

Also here, the message may optionally be encrypted to preserve the privacy of the user and prevent identity theft. Thus, method 200 described above may further comprise an optional step of, at the mobile terminal, encrypting information bits representing the second identifier.

### Time Measurements and Joint Time-Frequency Measurements

As described above, frequency measurements could be used as an optional feature in addition to time domain measurements, to reduce the number of satellites required for position validation. Time domain only measurements may be assumed to be default. The advantages of joint-time frequency positioning compared to this default are:
fewer satellites are required,
more equations/measurements are available for the same number of satellites, and
instantaneous user velocity can be determined.

On the other hand, additional efforts may be required for:
recording of transmit frequency at the mobile terminal,
measurement of received frequency at receiver satellites (with sufficient accuracy), and
weighting/scaling of frequency domain equations to time domain equations.

If only time measurements are available, N=4 satellites (receivers) will be required for 3D positioning, whereas N=3 satellites (receivers) will be required for two-dimensional (2D) positioning. On the other hand, if time and frequency measurements are available, N=3 satellites (receivers) will be required for 3D positioning, whereas N=2 satellites (receivers) will be required for 2D positioning.

### Impact of Parameters for Assisting Position Determination

As described above, the mobile terminal optionally can report its own position based on MEO-GNSS measurements and report the user delay ((re)transmission delay). One advantage of reporting the GNSS position and the user delay is that the position can be validated by computing Eqs. (2) and (6) instead of solving the inverse problem of Eqs. (4) and (8) for computing the position from scratch. Additional implementation efforts and complexity may result from the increased time required for the GNSS fix and the higher number of bits in the uplink message to transmit the GNSS position.

In some implementations, it might depend on the application or service offered to the user of the mobile terminal whether the mobile terminal should be required to report its GNSS position.

### Implementation Example: LEO-PNT Constellation

In some embodiments, techniques according to the present disclosure may be implemented by a constellation of satellites for positioning a mobile terminal. In general, the constellation may include a first satellite comprising a transmitter as described above, i.e., a transmitter for transmitting a first radio signal to the mobile terminal for prompting the mobile terminal to transmit a second radio signal, wherein the first radio signal corresponds to a first message (downlink message) and the second radio signal corresponds to a second message (uplink message). The constellation may further include a plurality of second satellites, each comprising a receiver for receiving the second radio signal. The first and second satellites may be configured to perform respective functionalities described above, including in particular transmission of first and reception of second messages, respectively, as described above, and downlinking of the information required for position determination or verification to a processing node (e.g., ground station).

One non-limiting example of such a constellation relates to a Low Earth Orbit Positioning, Navigation and Timing (LEO-PNT) satellite constellation in LEO (Reference [15]). The LEO-PNT constellation is envisioned to be deployed either as a dedicated constellation or hosted as secondary payload on another constellation in LEO. The payload will embark an onboard GNSS receiver to obtain time and position from MEO GNSS signals using state of the art Precise On-board Orbit Determination (P2OD) algorithms achieving decimeter accuracy or better. The Payload would further feature two-way links, thereby enabling methods according to embodiments of the disclosure.

### Technical Results

Next, technical results for techniques according to embodiments of the present disclosure will be described.

### Results of Simulation

First, example results of simulations of position validation will be described. Unless mentioned otherwise, the following default values were used during the simulation:

TABLE 1
Simulation Parameter Default Values

| Symbol | Value | Unit | Description |
|---|---|---|---|
| N | 4 | — | Number of satellites |
| Δt_{UE} | 1 | μs | User element processing delay |
| Nᵣₑₚ | 2000 | — | Number of runs per setting |
| f_{tx, UE} | 3 | GHz | User element transmission frequency |
| d_{fraud} | 100 | m | Distance offset compared to true |
| | | | position reported by fraudulent users |
| h₀ | 600 | km | Orbit height |
| UMA | 20 | Degrees | User masking angle (UMA) |
| σ_{D} | 20 | m | Standard deviation of stochastic noise |
| | | | on transmission time and frequency |
| | | | measurements |

The root mean square errors (RMSE) over multiple satellites—as defined in Eqs. (2) and (6) for time and time-frequency, respectively—are used as main figure of merit to compare the performance of the two different methods.

The mean RMSE is defined as the average RMSE over all Nrep runs of the simulation. The mean RMSE over all runs is shown as a solid line in the diagrams discussed below, whereas the transparent region around it illustrates the 1σ confidence interval.

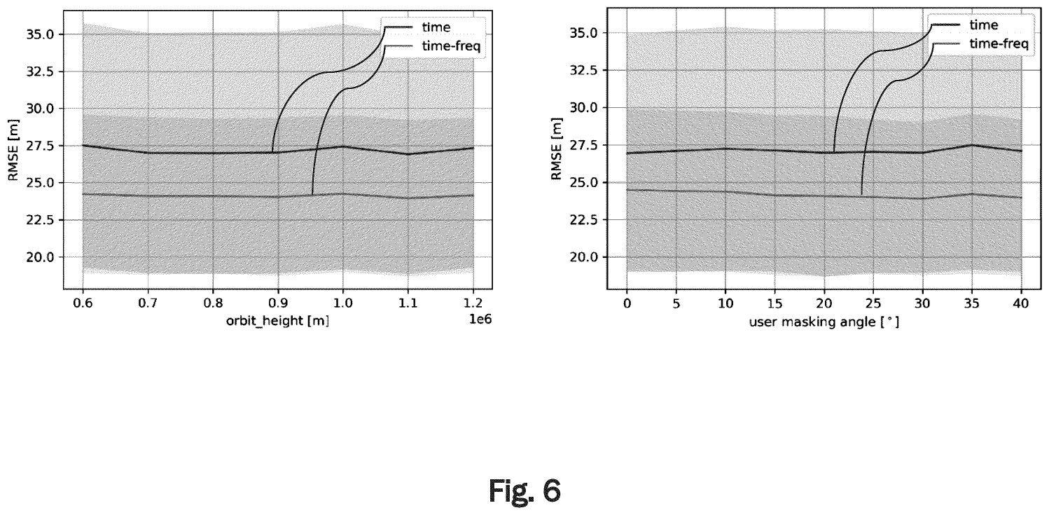

For an honest UE, i.e., one that is reporting its true position, processing delay, and transmission frequency, the RMS error (RMSE) should be zero assuming no noise and no modeling errors. The two diagrams of FIG. 6 show the RMS distance for the time-only determination method (dark grey curve; upper curve) and the time-frequency determination method (light grey curve; lower curve). The left diagram shows the RMS distance as a function of orbit height h₀, and the right diagram shows the RMS distance as function of user masking angle UMA. 1σ regions are indicated by shaded areas. As can be seen, the mean RMSE is constant in orbit height and user masking angle for both methods. The residual error is entirely due to the stochastic noise on time and frequency measurements which can be estimated as σ_{D}=20 m. The expected errors can be computed for the time domain method as

$$〈 {ε}_{T , rms} 〉 = \sqrt{2 {σ}_{D}^{2}} = \sqrt{2} {σ}_{D} , \qquad ( 9 )$$

since total variance is the sum of the individual variances and the stochastic noise applies twice because of the RTT measurement. For the joint time-frequency method the variance of time domain measurements and the frequency measurements can be averaged as

$$〈 {ε}_{TF , rms} 〉 = \sqrt{\frac{1}{2} 2 {σ}_{D}^{2} + \frac{1}{2} {σ}_{D}^{2}} = \sqrt{\frac{3}{2}} {σ}_{D} . \qquad ( 10 )$$

Notably, for the frequency domain measurements the stochastic noise term only applies once. The mean values in FIG. 6 match expectations with [symbol] ε_{T,rms} [symbol] =28.3 m for the time domain method and [symbol] ε_{TF,rms} [symbol] =24.5 m for the joint time-frequency method. Generally, it can be seen that joint time-frequency methods slightly outperform time domain methods, which is expected as per Eqs. (9) and (10). It should be noted that in real-world measurements, the accuracy of the frequency domain measurements might be lower than those of the time domain measurements, while for the simulation conducted here, similar noise levels were assumed.

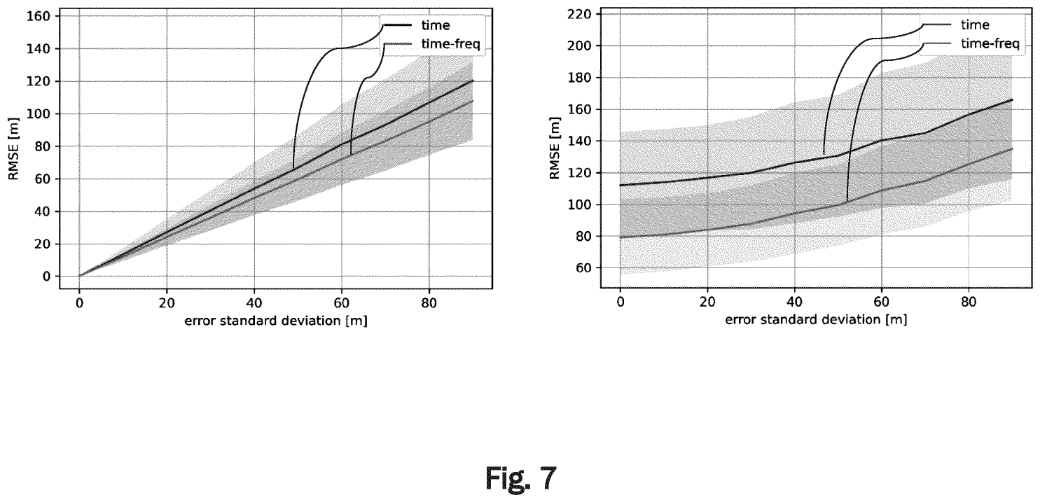

The proposed method is further verified in FIG. 7, where the mean RMSE is shown as a function of the noise standard deviation Op. The left diagram shows honest users, while the right diagram shows fraudulent users that manipulate their position. The orbit height is set constant at 600 km and the user masking angle at 20 degrees. Again, 1σ regions are indicated by shaded areas. For honest users, findings from the previous figure manifest themselves: The mean RMSE of both methods follow the linear relation shown in Eqs. (9) and 10, respectively.

The results in the right diagram of FIG. 7 show the RMSE of a fraudulent user that reports a position 100 m away from its true position, the direction of the offset is randomly generated from a uniform distribution of azimuth and elevation angles. It can be seen that fraudulent users lead to significantly higher RMSE values, which is expected and desired as it is intended to use this metric to detect fraudulent users. It should be noted that the fraudulent user only manipulates its position, however, it does not tamper with its reported user element processing delay and transmitted frequency in this simulation.

To gain a more in-depth look at detection of fraudulent users, the following figures will show the performance of the joint time-frequency method for different quantities.

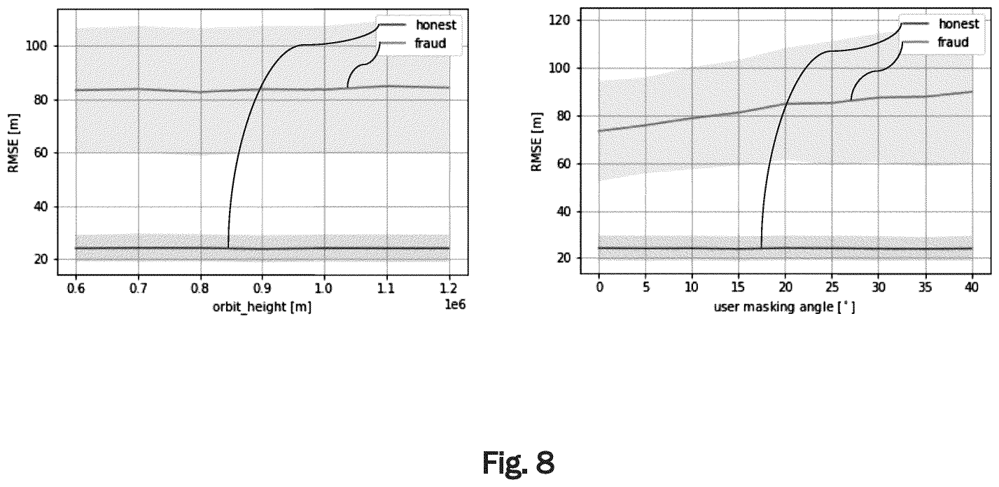

FIG. 8 shows the RMSE of the joint time-frequency method for honest users (dark grey curve; lower curve) and fraudulent users (light grey curve; upper curve) against orbit height in the left diagram and user masking angle in the right diagram, where 1σ regions are indicated by shaded areas. For the noise with σ_{D}=20 m as shown here, discrimination should mostly be possible for the whole range of illustrated orbit heights and UMAs.

It is worth noting that the mean RMSE of fraudulent users slightly increases with user masking angle while its variance also increases. For easy discrimination, a high RMSE with low variance would be desirable. It can be speculated that a geometric dilution of precision (GDOP)-like effect is responsible: As the UMA increases, it adversely affects the geometric diversity of available satellites. Thus, the contribution of the noise on the ranging measurement on the position accuracy grows bigger, increasing the mean RMSE and its variance.

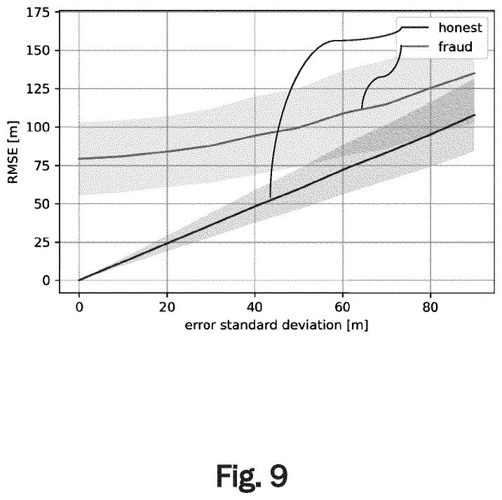

FIG. 9 shows the RMSE of honest and fraudulent users versus noise standard deviation OD, where 1σ regions are indicated by shaded areas. As expected, for higher noise discrimination becomes impossible, for σ_{D}=50 m even the 1σ regions overlap. Typically, in signal processing when making estimations from noisy samples with zero mean, one tries to increase the sample size to reduce the effect of noise. However, in this case this would mean increasing the number of satellites or taking multiple consecutive time samples. The former would increase the cost of a constellation while the latter would increase the time to validate a user's position, so neither is desirable. Alternatively, one could relax the allowed UE position error, which was set to 100 m in this simulation.

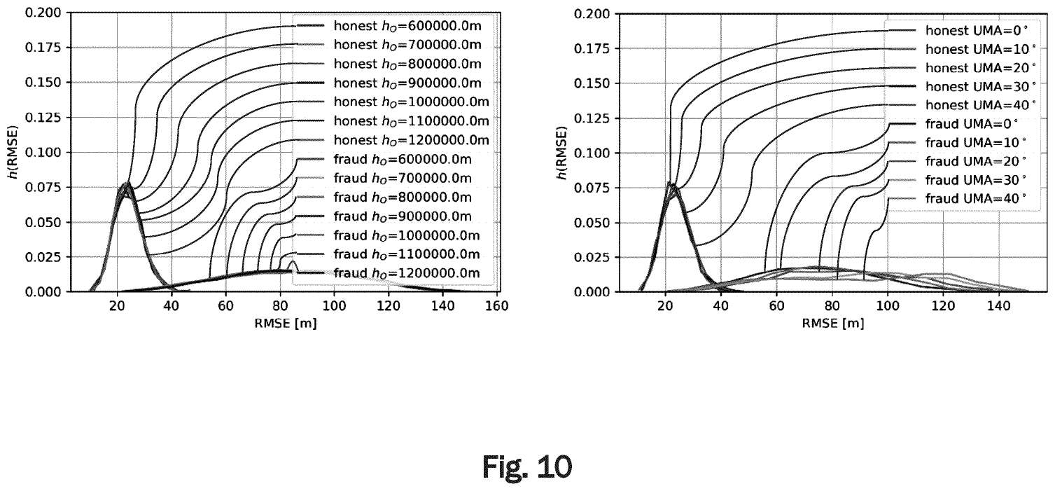

The probability distributions of the RMSE for honest and fraudulent users are shown in FIG. 10 for varying orbit height in the left diagram and varying user masking angle in the right diagram. The distributions seem invariant to orbit height in line with FIG. 8, while the distribution curve of the fraudulent users widening with its mean shifting slightly to the right for increasing UMA. As speculated earlier, this is likely due to worse GDOP conditions.

Besides, RMSEs are Gaussian-distributed both for fraudulent and honest users. The overlap of the PDFs is small, meaning it would allow detection of fraudulent users with good confidence for low σ_{D}.

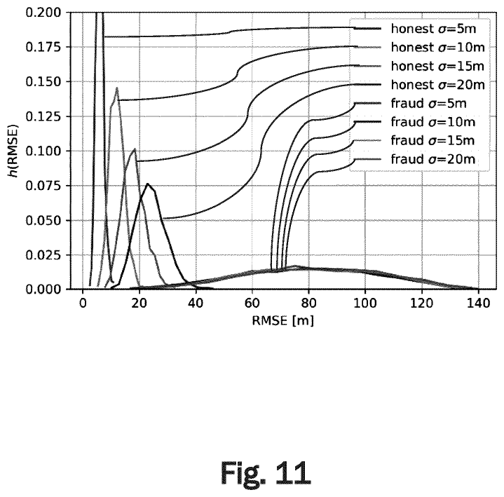

FIG. 11 shows the probability distribution of the RMS distance error for varying error standard deviation Op using time-frequency linear method on honest and fraudulent user data. As can be seen, the effect of decreasing noise standard deviation to as low as σ_{D}=5 m leaves the PDF of the fraudulent users mostly unaffected while it decreases mean and variance of the RMSE of honest users. For noise standard deviations of 10 m or lower one can with very high confidence detect fraudulent users.

The above simulation shows that fraudulent users falsifying their position by 100 m can be, under noise standard deviation of 10 m, confidently detected and rejected using the joint time-frequency method, which requires only N=3 satellites in Line of Sight (LOS).

Notably, while d_{fraud}=100 m was chosen rather arbitrarily, the relation between OD and d_{fraud} at which detection of fraudulent users is possible is independent of the absolute values.

Based on the simulations a noise level of

$${σ}_{D} ≅ 0.1 {d}_{fraud} , \qquad ( 11 )$$

or lower, will be sufficient to detect a fraudulent user.

This has clear implications for system implementation for a specific use case. If d_{fraud} is known for a given use case, OD gives the maximum allowed noise on time and frequency measurements. System accuracy requirements and subsequently hardware requirements can be derived from the maximum allowed noise.

### Uplink Capacity and Multiple Access

The uplink capacity is a technical challenge not to the concept of the present disclosure per se, but rather to specific implementations, such as for example in a LEO-PNT satellite system that is aimed at supporting a large number of users. Furthermore, the challenge of uplink capacity and multiple access applies to all two-way satellite communication and navigation systems.

In Appendix C, a simple calculation is made to establish a rough order of magnitude for the number of instantaneous users that can be supported by a single satellite in the uplink, coming to the conclusion that with CDMA DS-SS between 27k-500k instantaneous users could be supported.

Extensive work has been conducted in the past on multiple access in satellite communication. In particular, the Enhanced Spread-Aloha (E-SSA) (References [17], [18]). Further work on this matter has been published in References [19], [20].

### Technical Impact

Next, benefits of techniques according to the present disclosure benchmarked against state-of-the-art technologies will be described. The main benefits are a significant security improvement and the ability to provide new functions not existing in legacy solutions.

One important impact of the present disclosure lies in the security improvement to a number of attacks, including but not limited to:

For the use case of positioning, robustness to many classes of attacks, in particular Meaconing (interception and rebroadcast of navigation signals) by a 3rd party
User self-spoofing
Multi-site identity theft/collusion fraud
Message forging attacks

Specifically, compared to an uplink TDOA positioning system, two-way positioning according to the present disclosure adds the following security improvements:

TABLE 2
Security Improvement Compared to Uplink TDOA Positioning

| Uplink TDOA Positioning | Satellite-Based Two-Way Positioning |
|---|---|
| One-way ranging subject to | Two-way ranging makes meaconing attacks harder to |
| Man-in-the middle attacks. | implement since both downlink and uplink signals |
| | need to be manipulated. |
| User initiated protocol subject | Satellite initiated protocol can employ traffic |
| to message collisions or flooding | control strategies. |
| attacks. | |
| User-initiated one-way ranging | Two-way ranging is protected from collusion fraud by the |
| is vulnerable to collusion fraud. | unique information in the downlink message from the satellite. |
| One-way ranging does not allow | When employing the unpredictable random sequence in the |
| for time bounding or expiration | downlink message from the satellite, the expiration time of the |
| time of the message. | message can be used for time bounding, to reject expired |
| | messages and to make message forging attacks more difficult. |

It should be noted that while Uplink TDOA positioning is operational in space today on the GALILEO Search-and-Rescue (Reference [4]), the SAR Service is targeting a different use case with less challenges in terms of attacks, capacity and multiple access.

Further insights about the impact can be derived from a comparison with current asset tracking solutions (References [10], [11], [12], [13]). These solutions typically rely on the user to report their position, meaning they essentially rely on trusting the user and thus are vulnerable to all the aforementioned attacks. Thus, the security improvement over the current asset tracking solutions is evident.

Further, the function of providing the position of a non-trusted user in a secure manner (i.e., employing two-way positioning with uplink to multiple satellites) from space is not present in conventional technologies. Additional value can arise for example from atmospheric measurements (e.g., by radio occultation methods) as by-product of the two-way ranging.

In terms of complexity on the user segment-again compared to uplink TDOA as reference—the complexity may slightly increase at the user-side, as it has to receive the downlink signal in additional to transmitting the uplink signal. However, it can be assumed that the targeted users would already have a receiver for space-based navigation signals. Complexity increase at the space segment is marginal, if any.

As to accuracy, techniques according to the present disclosure are on par with reference technologies.

### Summary of Technical Advantages

The present disclosure provides techniques in the field of air-based or space-based (e.g., satellite-based) positioning. In particular, the present disclosure provides positioning methods and satellite constellations for positioning.

Current satellite-based positioning methods typically rely on broadcasted signals by GNSS. For uses cases where the position of an agent A needs to be reported to another agent B, a malevolent agent A could report a falsified GNSS position. This vulnerability of asset tracking applications is a gap in capabilities of state-of-the art GNSS.

The present disclosure mitigates this vulnerability by employing two-way position validation. Its core aspects include a two-way message exchange procedure, the message composition, and content and the position computation algorithm in combination with exploitation of joint time-frequency for two-way satellite-based positioning of non-trusted users. The proposed techniques overcome the weakness to several classes of meaconing, spoofing, and cyber-attacks of current GNSS-based asset tracking solutions. The unique property of these techniques compared to legacy solutions is that the position of the asset is validated by the satellite constellation and therefore inherently trustable.

Compared to conventional techniques based on one-way uplink signals, the present disclosure thereby offers increased robustness to added-delay attacks, uplink meaconing, user identity theft, and increases the cost of all classes of spoofing attacks using frequency information. In addition, better user identification, privacy and secrecy can be achieved using spread-spectrum codes and message encryption and the option to encrypt the downlink ranging signal to avoid its use by unauthorized users. The additional downlink required by techniques according to the present disclosure when embarked on a LEO-PNT system can be integrated into the navigation message of said system, thereby requiring only little additional effort for the downlink.

Further, compared to conventional asset tracking approaches, the present disclosure offers a satellite-validated position that is robust to spoofing attacks and not reliant on terrestrial infrastructure or the internet for communicating the position.

To summarize, by exploiting the downlink navigation signal in a satellite constellation and combining it with an uplink message, a two-way positing validation method is proposed that achieves—at negligible extra complexity-robustness against a multitude of attacks compared to conventional methods including legacy uplink TDOA.

### Interpretation

It is understood that any modules, units, or blocks described above may be implemented by a computer processor or respective computer processors, or the like. Modules, units or blocks described above may further be implemented in a cloud-based manner.

It should further be noted that the description and drawings merely illustrate the principles of the proposed method and system. Those skilled in the art will be able to implement various arrangements that, although not explicitly described or shown herein, embody the principles of the present disclosure and are included within its spirit and scope. Furthermore, all examples and embodiment outlined in the present document are principally intended expressly to be only for explanatory purposes to help the reader in understanding the principles of the proposed method and system. Furthermore, all statements herein providing principles, aspects, and embodiments of the present disclosure, as well as specific examples thereof, are intended to encompass equivalents thereof.

### Enumerated Example Embodiments

Aspects and implementations of the present disclosure may also be appreciated from the following enumerated example embodiments (EEEs), which are not claims.
EEE 1. A method for determining the position of a user element by way of a constellation of satellites in low Earth orbit (LEO), comprising:
at least one LEO satellite of said constellation of satellites in LEO transmitting downlink signaling, where said signaling includes: a unique identifier of said signaling from the at least one LEO satellite; and the time of transmission at the at least one LEO satellite;
the user element receiving the signaling from the at least one LEO satellite;
the user element transmitting an uplink signal including a unique identifier of said uplink signal;
the LEO satellites of the constellation of satellites in LEO receiving the uplink signal and measuring its times of arrival; and
determining the position of the user based on the time of transmission at the at least one LEO satellite, the time elapsed between receiving the signaling from the at least one LEO satellite and transmitting the uplink signal, the times of arrival measured at the LEO satellites, and the orbital positions of the LEO satellites.
EEE 2. The method of EEE 1, wherein:
the uplink signal further includes the carrier frequency of said uplink signal;
the LEO satellites of the constellation of satellites in LEO further measure the frequencies of arrival of the uplink signal; and
the method further comprises determining the position of the user further based on said frequencies of arrival measured at the LEO satellites.
EEE 3. The method of EEE 1 or EEE 2, wherein:
the uplink signal further includes the reported position of the user element determined based on signaling from a set of non-LEO navigation satellites; and
the method further include determining the position of the user further based on said reported position of the user element.
EEE 4. The method of any one of EEE 1 to EEE 3, wherein:
the uplink signal further includes the time elapsed between receiving the signaling from the at least one LEO satellite and transmitting the uplink signal.
EEE 5. The method of any one of EEE 1 to EEE 4, wherein:
the method further comprises encryption of the uplink signal; and/or the unique identifier of the uplink signal comprises an identifier of the user element transmitting said signal and a unique identifier of the downlink signaling.
EEE 6. The method of any one of EEE 1 to EEE 5, wherein:
the downlink signaling by the at least one LEO satellite comprises at least one of: encryption of said downlink signal; the unique identifier including an identifier of said LEO satellite; and/or the unique identifier including a randomly generated bit sequence that is non-predictable by the user element or other outside parties; and
wherein the downlink signaling is renewed after reaching a pre-defined expiration time.
EEE 7. The method of any one of EEE 1 to EEE 6, wherein:
the constellation of satellites in LEO is able to simultaneously service multiple users, employing at least one of: time division multiple access (TDMA); frequency division multiple access (FDMA); and/or code division multiple access (CDMA).

### CONCLUSION

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

### REFERENCES

[1] European Union Agency for the Space Programme (EUSPA), EUSPA EO and GNSS Market Report, Luxembourg: Publications Office of the European Union, 2022.
[2] K. C. Ho and Y. T. Chan, “Solution and Performance Analysis of Geolocation by TDOA,” IEEE Transactions on Aerospace and Electronic Systems, vol. 29, no. 4, pp. 1311-1322, 1993.
[3] A. H. Sayed, A. Tarighat and N. Khajehnouri, “Network-Based Wireless Location, Challenges faced in developing techniques for accurate wireless location information,” IEEE SIGNAL PROCESSING MAGAZINE, vol. 22, no. 4, pp. 24-40, 2005.
[4] European GNSS Service Centre, SAR/GALILEO SERVICE DEFINITION DOCUMENT, 2016.
[5] J. Petrek, “A satellite based localisation service using a 3G mobile phone as an emergency terminal,” in 25th International Conference Radioelektronika, Pardubice, 2015.
[6] D. P. Haworth, S. Boyer and C. W. Martin, “POSITION LOCATION FOR ACCESS POLICING OF SATELLITE SYSTEMS FOR MOBILE COMMUNICATIONS,” in Satellite Systems for Mobile Communications and Navigation, London, 1996.
[7] A. N. Skauen, “Quantifying the tracking capability of space-based AIS systems,” Advances in Space Research, pp. 527-542, 28 Nov. 2016.
[8] Atos SE, “Satellite Geolocation Service,” [Online]. Available: https://atos.net/en/solutions/aerospace-defense-electronics/skymon/satellite-geolocation-service.
[9] P. Ellis, V. Irisov, G. Pojani, S. Binda, H. Khan, J. Cappaert, T. Yuasa and O. N. Correig, “GNSS Interference Monitoring from LEO using the Spire Constellation,” in The 4S Symposium 2022, Vilamoura, 2022.
[10] Bluecats, “Bluecats GNSS Asset Tracking,” [Online]. Available: https://www.bluecats.com/gnss-asset-tracking/.
[11] D. Grassi and G. Solito, “GPS: Too power-hungry for small asset tracking solutions? Not necessarily,” u-blox, 15 Jul. 2021. [Online]. Available: https://www.u-blox.com/en/blogs/insights/small-asset-tracking-solutions-GPS.
[12] Concox Information Technology Co., Ltd, “PG201 Intelligent Personal Tracker,” [Online]. Available: https://www.iconcox.com/products/intelligent-personal-tracker.html.
[13] PEW trusts, “Use of Electronic Offender-Tracking Devices Expands Sharply-Number of monitored individuals more than doubled in 10 years,” https://www.pewtrusts.org/en/research-and-analysis/issue-briefs/2016/09/use-of-electronic-offender-tracking-devices-expands-sharply, 7 Sep. 2016. [Online].
[14] Comparesoft, “When to Use GPS Asset Tracking for Real-Time Location Data,” November 2021. [Online]. Available: https://comparesoft.com/assets-tracking-software/gps-asset-tracking/.
[15] L. Ries, M. Cordero Limon, F.-C. Grec, M. Anghileri, R. Prieto-Cerdeira, F. Abel, J. Miguez, J. V. Perello-Gisbert, S. d′Addio, R. Ioannidis, A. Ostillio, M. Rapisarda and R. Sarnadas, “LEO-PNT for augmenting Europe's space-based PNT capabilities,” in IEEE/ION PLANS, Monterey, California, 2023.
[16] European Space Agency, “ESA plans for low-orbiting navigation satellites,” 26 10 2022. [Online]. Available: https://www.esa.int/Applications/Navigation/ESA_plans_for_low-orbiting_navigation_satellites.
[17] R. De Gaudenzi, “TRANSMIT POWER CONTROL METHOD AND TERMINAL IN A SPREAD-SPECTRUM UNSLOTTED RANDOM ACCESS COMMUNICATION SYSTEM”. Patent EP2944130A1, 3 Jan. 2014.
[18] O. Del Rio Herrero and R. De Gaudenzi, “Methods, apparatuses and system for asynchronous spread-spectrum communication”. Patent EP2159926B1, 26 08 2008.
[19] O. Del Rio Herrero and R. De Gaudenzi, “High Efficiency Satellite Multiple Access Scheme for Machine-to-Machine Communications,” IEEE Transactions on Aerospace and Electronic Systems, vol. 48, no. 4, pp. 2961-2989, 2012.
[20] S. Cioni, R. De Gaudenzi, O. Del Rio Herrero and N. Girault, “On the Satellite Role in the Era of 5G Massive Machine Type Communications,” IEEE Network, vol. 32, no. 5, pp. 54-61, 2018.
[21] S. Boyd and L. Vandenberghe, Convex Optimization, New York: Cambridge University Press, 2004.
[22] A. Goldsmith, Wireless Communications, Cambridge: Cambridge University Press, 2005.
[23] I. Fernandez-Hernandez, “Digitally-signed satellite radio-navigation signals”. Belgium Patent EP2824480, 2013 Jul. 9.

### Appendix A

Derivation of Ranging Cost Functions from Time and Frequency Measurements

This appendix contains the derivation of ranging equations in the time domain (Eq. (1)) and frequency domain (Eq. (5)).

For a message transmitted from satellite 1 at time t_{tx,S1}, received by the user element (UE) and retransmitted after delay Δt_{UE} and then received by satellite k at time t_{rx,Sk,S1}, the difference between transmission and reception at the satellites k is

$${t}_{rx , Sk , S 1} - {t}_{tx , S 1} = {τ}_{1} + Δ {t}_{UE} + {τ}_{k} , \qquad ( 12 )$$

where the propagation time of an electromagnetic wave between the user element and the satellite k is

$${τ}_{k} = {c}^{- 1} ‖ {p}_{UE} - {p}_{Sk} ‖ , \qquad ( 13 )$$

where c is the propagation speed of the electromagnetic wave and p_{UE}, p_{Sk}∈ [symbol] ^{N}^{_{D}}^{×1} are positions of the user element and satellite k, respectively. N_{D} is the dimension of the position vector, typically N_{D}=3. Inserting Eq. (13) into Eq. (12) and multiplying by c yields

$$c ( {t}_{tx , S 1} + Δ {t}_{UE} - {t}_{rx , Sk , S 1} ) = ‖ {p}_{UE} - {p}_{Sk} ‖ + ‖ {p}_{Ue} - {p}_{S 1} ‖ . \qquad ( 14 )$$

With four scalar unknowns—Δt_{UE} and the three components of p_{UE}—four satellites are required to achieve a fully determined system of equations. The positions of the satellites and times measured at the satellites are known to the system.

One can solve for 0 and thereby formulate the cost function with unit [meters] in Eq. (1).

Due to the motion of the satellite k relative to the user element, an electromagnetic wave transmitted from one to the other is subject to a Doppler shift that can be expressed as difference between received and transmitted frequency as

$${f}_{rx , Sk , S 1} - {f}_{tx , UE} = {f}_{D , Sk} , \qquad ( 15 )$$

where f_{D,Sk} is the Doppler frequency shift between satellite k and the user element and f_{tx,UE} and f_{rx,Sk,S1} are the frequency transmitted by the UE and the frequency received by the receiving satellite k, respectively. Besides, the Doppler velocities f_{D,Sk} can be expressed as a function of the positions and velocities as

$${f}_{D , Sk} = {f}_{tx , UE} {c}^{- 1} {v}_{r , UE , Sk} = {f}_{tx , UE} {c}^{- 1} {v}_{Sk}^{T} \frac{{p}_{UE} - {p}_{sk}}{‖ {p}_{UE} - {p}_{sk} ‖} , \qquad ( 16 )$$

where v_{r,UE,Sk} is the radial velocity between satellite k and user element. Vector v_{Sk}∈ [symbol] ∈^{N}^{_{D}}^{×1} is the relative velocity of the UE and satellite k. Equating Eq. (15) and Eq. (16), solving for 0, multiplying by c, and dividing by f_{tx,UE} yields

$$0 = {v}_{Sk}^{T} \frac{{p}_{UE} - {p}_{sk}}{‖ {p}_{UE} - {p}_{sk} ‖} - c \frac{{f}_{rx , Sk , S 1} - {f}_{tx , UE}}{{f}_{tx , UE}} . \qquad ( 17 )$$

The error term on the right-hand-side has the unit [meters per second], however, for a joint time frequency approach the cost functions for time and frequency measurements need to be formulated in the same units to be used in conjunction. Multiplication for example by the propagation delay according to Eq. (13) scales Eq. (17) to yield the cost function of Eq. (5) in units [meters]. Further scaling might be applied in accordance with relative importance (e.g., based on accuracy, confidence) of the time-domain and frequency-domain contributions.

The satellites' kinematics p_{Sk}, v_{Sk} and the measured frequencies f_{tx,UE} and f_{rx,Sk,S1} are known, for example to the satellites. The user position and transmit frequency need to be validated or computed.

### Appendix B

### Convexity of the Time Domain Cost Function

This appendix proves the convexity of the time domain cost function. The property of convexity is a sufficient condition for solving the ranging cost functions. Four properties taken from Boyd and Vandenberghe (Reference [21]) are used for the proof.

### Property I

“All linear and affine functions are convex” (Reference [21, pp. 71-72], subsection 3.1.5).

### Property II

“Every norm on [symbol] ⁿ is convex” (Reference [21, pp. 71-72], subsection 3.1.5).

### Property III

“A nonnegative weighted sum of convex functions is convex” (Reference [21, p. 79], subsection 3.2.1).

### Property IV

A squared Euclidean norm preserves convexity, as shown in Reference [21, p. 89], subsection 3.2.6.

Using these properties, it is straightforward to prove convexity of the time domain cost function in Eq. (2) that is used to perform the positioning according to embodiments of the disclosure.

Recalling that the time domain error received at satellite k is defined in Eq. (1) as

$${ε}_{T , k} ( x ) = {\underbrace{‖ {p}_{UE} - {p}_{sk} ‖}}_{A} + {\underbrace{‖ {p}_{U E} - {p}_{S 1} ‖}}_{B} + {\underbrace{c ( {t}_{tx , S 1} + Δ {t}_{UE} - {t}_{rx , Sk , S 1} ) ,}}_{C} \qquad ( 18 )$$

where x=[p_{UE} Δt_{UE}] T. Terms A and B are norms, therefore convex as per property II. Term C is an affine function, thus convex as per property I. Function ε_{T,k} is convex in x following property III, as it is a sum of the three convex functions A, B and C.

The RMSE time domain cost function to be minimized, as shown in Eq. (2), can be also expressed as an L2 norm

$${ε}_{T , rms} = \sqrt{\frac{1}{N} {\sum }_{k = 1}^{N} {ε}_{T , k}^{2}} = ‖ {ε}_{T} ‖ , \qquad ( 19 )$$

where ε_{T}=[ε_{T,1} . . . ε_{T,N}]^{T}. To solve the optimization in Eq. (4), it is required to find the argument \hat{x} to minimize ε_{T,rms}(x). The optimal \hat{x} minimizes not only the norm but also the norm squared as shown in Reference [21, p. 131]. This allows to formulate the equivalent problem of minimizing the norm squared as

$$\hat{x} = arg {min}_{x} ‖ {ε}_{T} ‖ = {argmin}_{x} {‖ {ε}_{T} ‖}^{2} . \qquad ( 20 )$$

The equivalent problem is convex following property IV. It has thus been shown that the optimization problem formulated in Eq. (4) can be solved using convex optimization.

### Appendix C

### Multiple Access DS-SS CDMA Uplink

Multiple access of the users of the positioning system is one major challenge. In this appendix, a CDMA uplink scheme is proposed using Direct Sequence Spread Spectrum (DS-SS) techniques. The goal is to obtain a first estimate about how many users could be served simultaneously on a single satellite, following an approach from Goldsmith (Reference [22, pp. 424-436]).

Let K be the number of users in view of a single satellite and r_{b} be the required bitrate per single user. The required symbol rate per user and corresponding information bandwidth are then given by

$${r}_{s} = {r}_{b} {log}_{2} M , \qquad ( 21 )$$

$${r}_{s} = {r}_{b} {log}_{2} M , \qquad ( 22 )$$

where M is the order of modulation. Setting M=2 assuming binary phase shift keying (BPSK) leads to rₛ=r_{b}.

The bandwidth of the chipped DS-SS signal is

$${B}_{c} = \frac{1}{{T}_{c}} , \qquad ( 23 )$$

where T_{c} is the chip time, i.e., the duration of one spreading signal code. The processing gain or spreading factor of a DS-SS system is

$$G = \frac{{B}_{c}}{B} \approx \frac{{T}_{s}}{{T}_{c}} , \qquad ( 24 )$$

where

$${T}_{s} = \frac{1}{{r}_{s}}$$

is the symbol time.

The bit error rate using BPSK modulation as function of the Signal to Noise Ratio (SNR) at the demodulation threshold is given by

$${P}_{b} = Q ( \sqrt{2 S N R} ) ⇔ S N R = \frac{1}{2} {( {Q}^{- 1} ( {P}_{b} ) )}^{2} , \qquad ( 25 )$$

with Q(⋅) being the tail distribution function of the standard normal distribution.

Due to the large number of expected users, let the system be interference limited, rather than noise limited, thus allowing to represent the expected SNR at the receiver as Signal to Interference Ratio (SIR).

For maximum number of users of an uplink DS-SS system, one can distinguish between three cases outlined in Reference [22].

First, a synchronized system with orthogonal codes, for example using Walsh-Hadamard codes, will have zero cross-correlation and thus no interference. The number of users in such a system would be limited by the number of available orthogonal codes, which is equal to the processing gain as K=G. This is under the assumption that each uplink user could send a signal with an SNR at the receiving satellites above the demodulation threshold of Eq. (25).

Second, consider a case where users are synchronized, but codes are non-orthogonal. This could be due to a regulatory or technical bandwidth limitation that limits the code length and thereby the number of available orthogonal codes, i.e., G<K. The SIR of a synchronous non-orthogonal system is given by

$$S I R = \frac{G}{K - 1} ⇔ K = 1 + ⌊ \frac{G}{S I R} ⌋ . \qquad ( 26 )$$

Third, consider a case where users are asynchronous. In that case, interference between different uplink users cannot be avoided and the codes are treated as non-orthogonal in which case the signal to inference ratio (SIR) is given by

$$S I R = \frac{3 G}{K - 1} ⇔ K = 1 + ⌊ \frac{3 G}{S I R} ⌋ . \qquad ( 27 )$$

Setting parameters for the required bit rate, bit error probability, and the channel bandwidth, Eqs. (21)-(27) can be employed to compute the number of users that can be served by a single satellite simultaneously in the three aforementioned cases.

For an estimated bitrate r_{b} of 100 bit/s (ROM estimate), a channel bandwidth B_{c} of 500 MHz (Reference [23, p. 23]), a modulation order M=2 (BPSK modulation), a bit error probability P_{b}=10-5 (conservative assumption), one will find a number of users K=500·10³ (K=G) for the sync orthogonal case, K=27·10³ (cf. Eq. (26)) for the sync non-orthogonal case, and K=82·10³ (cf. Eq. (27)) for the async non-orthogonal case.

While the derivation and results presented in this appendix provide a reasonable first estimate of the number of users, there may be limitations, including not addressing near-far effects, not considering additional noise and link budget limitations, strong assumptions on the channel model, etc.

1. A method of air-based and/or space-based positioning of a mobile terminal for determining or verifying a position of the mobile terminal, the method comprising:
at an airborne or spaceborne transmitter, transmitting a first radio signal to the mobile terminal for prompting the mobile terminal to transmit a second radio signal, wherein the first radio signal corresponds to a first message;
at the mobile terminal, in response to receiving the first radio signal, transmitting the second radio signal, wherein the second radio signal corresponds to a second message;
receiving the second radio signal at a plurality of airborne or spaceborne receivers; and
determining or verifying the position of the mobile terminal based on a time of transmission of the first radio signal at the airborne or spaceborne transmitter and times of reception of the second radio signal at respective ones of the plurality of airborne or spaceborne receivers.

2. The method according to claim 1, wherein the first message includes a first identifier that identifies the airborne or spaceborne transmitter.

3. The method according to claim 2, wherein the first identifier includes a pseudo-random bit sequence that is repeatedly updated at the airborne or spaceborne transmitter.

4. The method according to claim 2, wherein the second message includes a second identifier identifying the mobile terminal; and
wherein the second identifier includes a portion that is generated, at the mobile terminal, based on the first identifier.

5. The method according to claim 1, further comprising:
measuring, at the respective ones of the plurality of airborne or spaceborne receivers, frequencies of the second radio signal upon arrival,
wherein determining or verifying the position of the mobile terminal is further based on the frequencies of the second radio signal measured at the respective ones of the plurality of airborne or spaceborne receivers.

6. The method according to claim 1, wherein the second message further includes an indication of a frequency of transmission of the second radio signal at the mobile terminal; and
wherein determining or verifying the position of the mobile terminal is further based on the frequency of transmission of the second radio signal at the mobile terminal.

7. The method according to claim 1, wherein the second message includes an indication of one or more parameters for assisting determination or verification of the position of the mobile terminal;
wherein the one or more parameters for assisting determination or verification of the position of the mobile terminal include at least one of:
a transmission delay between reception of the first radio signal and transmission of the second radio signal at the mobile terminal; and/or
one or more components of a position of the mobile terminal; and
wherein determining or verifying the position of the mobile terminal is further based on the one or more parameters for assisting determination or verification of the position of the mobile terminal.

8. The method according to claim 1, wherein determining or verifying the position of the mobile terminal comprises:
determining a cost function based on the time of transmission of the first radio signal at the airborne or spaceborne transmitter and the times of reception of the second radio signal at the respective ones of the plurality of airborne or spaceborne receivers; and
determining or verifying the position of the mobile terminal based on the cost function.

9. The method according to claim 8, further comprising:
measuring, at the respective ones of the plurality of airborne or spaceborne receivers, frequencies of the second radio signal upon arrival,
wherein the cost function is further based on the frequencies of the second radio signal measured at the respective ones of the plurality of airborne or spaceborne receivers.

10. The method according to claim 8, further comprising:
measuring, at the respective ones of the plurality of airborne or spaceborne receivers, frequencies of the second radio signal upon arrival,
wherein the second message further includes an indication of a frequency of transmission of the second radio signal at the mobile terminal, and
wherein the cost function is further based on the frequencies of the second radio signal measured at the respective ones of the plurality of airborne or spaceborne receivers and the frequency of transmission of the second radio signal.

11. The method according to claim 8, wherein the second message includes an indication of one or more parameters for assisting determination or verification of the position of the mobile terminal;
wherein the one or more parameters for assisting determination or verification of the position of the mobile terminal include at least one of:
a transmission delay between reception of the first radio signal and transmission of the second radio signal at the mobile terminal; and/or
one or more components of a position of the mobile terminal; and
wherein the cost function is further based on the one or more parameters for assisting determination or verification of the position of the mobile terminal.

12. The method according to claim 8, wherein determining or verifying the position of the mobile terminal based on the cost function includes minimizing the cost function to estimate the position of the mobile terminal.

13. The method according to claim 12, wherein determining or verifying the position of the mobile terminal using the cost function includes jointly determining a position of the mobile terminal and a transmission delay between reception of the first radio signal and transmission of the second radio signal at the mobile terminal that minimize the cost function.

14. The method according to claim 8, wherein the second message includes an indication of a self-reported position of the mobile terminal; and
wherein the cost function is further based on the self-reported position.

15. The method according to claim 14, wherein the self-reported position of the mobile terminal is a Global Navigation Satellite System (GNSS) based position.

16. The method according to claim 14, wherein verifying the position of the mobile terminal includes comparing the cost function to a threshold.

17. The method according to claim 1, wherein the first message includes an indication of a time of transmission of the first radio signal at the airborne or spaceborne transmitter.

18. The method according to claim 2, further comprising:
at the airborne or spaceborne transmitter, encrypting information bits representing the first identifier.

19. The method according to claim 4, further comprising:
at the mobile terminal, encrypting information bits representing the second identifier.

20. The method according to claim 8, wherein the cost function is given by
$${ε}_{T , rms} = \sqrt{\frac{1}{N} {\sum }_{k = 1}^{N} {( {ε}_{T , k} )}^{2}} ,$$
$$with$$
$${ε}_{T , k} = ‖ {p}_{UE} - {p}_{Sk} ‖ + ‖ {p}_{UE} - {p}_{S 1} ‖ + c ( {t}_{tx , S 1} + Δ {t}_{UE} - {t}_{rx , Sk , S 1} ) ,$$
where N denotes the number of airborne or spaceborne receivers, k=1, . . . , N denotes a given one among the plurality of airborne or spaceborne receivers, p_{UE} denotes the position of the mobile terminal, p_{Sk} denotes a position of the k-th airborne or spaceborne receiver, p_{S1} denotes a position of the airborne or spaceborne transmitter, t_{tx,S1} denotes the time of transmission of the first radio signal at the airborne or spaceborne transmitter, t_{rx,Sk,S1} denotes the time of reception of the second radio signal at the k-th airborne or spaceborne receiver, Δt_{UE} denotes the transmission delay between reception of the first radio signal and transmission of the second radio signal at the mobile terminal, and c denotes the speed of light.

21. The method according to claim 10, wherein the cost function is given by
$${ε}_{TF , rms} = \sqrt{\frac{1}{2 N} {\sum }_{k = 1}^{N} {( {ε}_{T , k} )}^{2} + {( {ε}_{F , k} )}^{2}} ,$$
$$with$$
$${ε}_{T , k} = ‖ {p}_{UE} - {p}_{sk} ‖ + ‖ {p}_{UE} - {p}_{S 1} ‖ + c ( {t}_{tx , S 1} + Δ {t}_{UE} - {t}_{rx , Sk , S 1} )$$
$$and$$
$${ε}_{F , k} = w ( {v}_{Sk}^{T} \frac{{p}_{UE} - {p}_{sk}}{‖ {p}_{UE} - {p}_{sk} ‖} - c \frac{{f}_{rx , Sk , S 1} - {f}_{tx , UE}}{{f}_{tx , UE}} ) ,$$
where N denotes the number of airborne or spaceborne receivers, k=1, . . . , N denotes a given one among the plurality of airborne or spaceborne receivers, p_{UE} denotes the position of the mobile terminal, p_{Sk} denotes a position of the k-th airborne or spaceborne receiver, p_{S1} denotes a position of the airborne or spaceborne transmitter, t_{tx,S1} denotes the time of transmission of the first radio signal at the airborne or spaceborne transmitter, t_{rx,Sk,S1} denotes the time of reception of the second radio signal at the k-th airborne or spaceborne receiver, Δt_{UE} denotes the transmission delay between reception of the first radio signal and transmission of the second radio signal at the mobile terminal, w denotes a weighting factor of unit [seconds], v_{Sk} denotes a velocity of the k-th airborne or spaceborne receiver, f_{tx,UE} denotes the frequency of transmission of the second radio signal at the mobile terminal, f_{rx,Sk,S1} denotes the frequency of the second radio signal measured at the k-th airborne or spaceborne receiver, and c denotes the speed of light.

22. The method according to claim 21, wherein the weighting factor w is given by
$$w = {c}^{- 1} ‖ {p}_{UE} - {p}_{sk} ‖ .$$

23. The method according to claim 1, further comprising:
collecting, at a processing node, the time of transmission of the first radio signal at the airborne or spaceborne transmitter and the times of reception of the second radio signal at the respective ones of the plurality of airborne or spaceborne receivers; and
determining or verifying the position of the mobile terminal at the processing node.

24. The method according to claim 23, wherein the processing node is implemented by one or more of: a user terminal, the airborne or spaceborne transmitter, one or more of the airborne or spaceborne receivers, and/or a ground station.

25. The method according to claim 23, further comprising:
collecting, at the processing node, a frequency of transmission of the second radio signal at the mobile terminal and/or frequencies of the second radio signal measured at the respective ones of the plurality of airborne or spaceborne receivers.

26. The method according to claim 1, wherein the airborne or spaceborne transmitter and the plurality of airborne or spaceborne receivers are implemented by a plurality of satellite-based transceivers.

27. A constellation of a plurality of satellites for positioning of a mobile terminal, the plurality of satellites including:
a first satellite comprising a transmitter for transmitting a first radio signal to the mobile terminal for prompting the mobile terminal to transmit a second radio signal, wherein the first radio signal corresponds to a first message and the second radio signal corresponds to a second message; and
a plurality of second satellites, each comprising a receiver for receiving the second radio signal,
wherein the first satellite is adapted to transmit an indication of a time of transmission of the first radio signal at the airborne or spaceborne transmitter to the mobile terminal or a processing node; and
wherein each of the second satellites is adapted to transmit an indication of a time of reception of the second radio signal at the respective second satellite to the processing node.

28. The constellation according to claim 27, wherein the processing node is implemented by one or more of: a user terminal, the first satellite, one or more of the second satellites, and/or a ground station.

29. The constellation according to claim 27- or 28, wherein the second message includes an indication of a frequency of transmission of the second radio signal at the mobile terminal; and
wherein each of the second satellites is further adapted to transmit the indication of the frequency of transmission of the second radio signal at the mobile terminal and/or an indication of a frequency of the second radio signal measured at the respective second satellite to the processing node.

30. The constellation according to claim 27, wherein the second message includes an indication of one or more parameters for assisting determination or verification of the position of the mobile terminal;
wherein the one or more parameters for assisting determination or verification of the position of the mobile terminal include at least one of:
a transmission delay between reception of the first radio signal and transmission of the second radio signal at the mobile terminal; and/or
one or more components of a position of the mobile terminal; and
wherein each of the second satellites is further adapted to transmit the indication of the one or more parameters for assisting determination or verification of the position of the mobile terminal to the processing node.

31. The constellation according to claim 27, wherein the first message includes a first identifier that identifies the first satellite, and wherein the first satellite is further adapted to transmit the first identifier to the processing node; and/or
wherein the second message includes a second identifier that identifies the mobile terminal, and wherein each of the second satellites is further adapted to transmit the second identifier to the processing node.
